(19) United States
(12) Patent Application Publication
(10) Pub. No.: US 2013/0344968 A1
(43) Pub. Date: Dec. 26, 2013

(54) SYSTEM AND METHOD FOR EXTRACTING VALUE FROM GAME PLAY DATA

(71) Applicant: Knack.it Corp., Palo Alto, CA (US)

(72) Inventors: Guy Halfteck, Palo Alto, CA (US); John Funge, Palo Alto, CA (US)

(73) Assignee: Knack.it Corp., Palo Alto, CA (US)

(21) Appl. No.: 13/910,992

(22) Filed: Jun. 5, 2013

Related U.S. Application Data
(63) Continuation-in-part of application No. 13/668,036, filed on Nov. 2, 2012, now abandoned.
(60) Provisional application No. 61/655,661, filed on Jun. 5, 2012.

(51) Int. Cl. A63F 13/00

(52) U.S. Cl. CPC A63F 13/00
USPC 463/43

(57) ABSTRACT

A system and method for extracting game play data are provided. The system and method may be used, for example, in an employment embodiment, a school and/or college and/or university embodiment, a dating embodiment, an advertising embodiment, and other embodiment in which it is desirable to be able to extract information from game play data.

### PRIORITY CLAIMS

### Related Applications

This application claims the benefit under 35 USC 119(e) and 120 to U.S. Provisional Patent Application Ser. No. 61/655,661 filed on Jun. 5, 2012 and entitled “System and Method for Extracting Value from Game Data” and is a continuation in part of U.S. patent application Ser. No. 13/668,036, filed on Nov. 2, 2012, the entirety of both of which are incorporated herein by reference.

### APPENDICES

Appendix A shows some of the personal human attributes the system can measure.

Appendix B is a technical presentation that describes some aspects of the system and method.

All of the appendices above form part of the specification and are specifically incorporated by reference into the specification.

### FIELD

The disclosure relates to the analysis of data that includes data generated from the playing of computer games and meta-games. The data and the results of the data analysis are valuable to measuring a broad range of personality attributes and to predicting individual and group behavior and choices, including performance, fit and compatibility, decisions, and preferences in a variety of areas such as predicting job performance, fit and compatibility, and preferences; predicting primary, secondary and post-secondary school performance, academic achievement, educational fit and compatibility, and preferences; predicting fit, compatibility, preferences and performance in vocational and non-vocational training, personal development, cognitive training, and re-training; predicting fit, compatibility, preferences and performance relating to professional career choices and directions; predicting product, goods and service preferences and compatibility, and product, goods and service purchase, suitability, use and consumption decisions and tendencies; predicting content and media consumption preferences and compatibility; predicting consumer purchase behavior in general and consumer attention and purchasing response to advertising, promotions and other forms of solicitation, marketing and sales techniques; predicting purchase, fit and suitability of investment and other financial products, including investment management services, investment products, insurance and risk-management products, mortgage, credit and other debt products, and the like; predicting preferences and compatibility in dating, social discovery, and matching applications; diagnosing and predicting medical, mental, psychological and other health-related conditions; predicting preferences, compatibility, response and outcomes in personalized health care programs and regimens; and predicting other outcomes, choices, and behaviors.

The data analysis can also measure, discover and describe personal attributes, abilities, aptitudes, characteristics, competencies, dispositions, traits, and skills that can, in turn, be used in further analyses and applications in individual, group, and organizational settings.

### BACKGROUND

Measuring and predicting human personality, preferences, choices and behavior is very complicated. Writing program code to analyze data that includes data generated from the playing of computer games can be difficult. This is because the relationship between the ways a person plays a computer game and how these relate to their personality, preferences, and behaviors in other areas is complicated. For example, it is not the case that a person's score in a computer game like Angry Birds would necessarily make a good way to predict that same person's performance if they were hired by a company like Google as a software engineer.

In other non-game applications it is known that people's Internet search behavior and email contents can be valuable data in predicting preferences such as the kind of products they might be interested in. For example, Google uses search terms to target and personalize advertising.

It is also known that the type of products people have previously purchased or used can predict future products choices and preferences. For example, Amazon and Google use previous behavior to recommend products and movies.

Game companies have also looked at data generated from the playing of computer games to improve their games. For example, if they notice that many players quit playing the game after a certain point they may make changes to the game until they see that less people quit at that point. Game companies have also created systems to match people in online games so that a player can play against people of comparable game-playing skill.

However, no system or method is known in which game data is used for applications outside of games such as measuring, uncovering, assessing, and determining people's personality traits, abilities, aptitudes, characteristics, competencies, dispositions, preferences, and skills; predicting job performance; predicting academic and other achievement outcomes; predicting product and service preferences; predicting content consumption preferences and compatibility; predicting compatibility in dating applications; and predicting fit, outcomes, and preferences in other domains mentioned above.

There are many traditional assessment companies and practices that use traditional surveys and questionnaires to attempt to uncover personality traits and abilities. In general, these use self-report questions and tasks. However, questionnaires and tasks are known to have problems with engagement and motivation, anxiety, stereotype threat, accuracy, depth, breadth, fidelity, and lack of dynamic interplay between attributes—and, in turn, with data quality and predictive value. For example, taking a long survey can be boring so that answers, especially toward the end of the survey, can be provided without sufficient thought. It is also often easy for people to, consciously or subconsciously, misrepresent themselves in a survey since the participant may easily glean answers that might be considered desirable.

In contrast, it has been discovered by the present inventors that games provide a superior interface to collecting data because they increase naturalistic engagement for even long periods of time and collect data about one's behavior and performance, not one's self-reported answers. The sense of engagement and being “in the state of flow” also causes people to forget that the game—in addition to being entertaining and engaging—uncovers their personality attributes, thereby minimizing external interferences and increasing data quality. In addition, it is often hard for players to infer how attributes are being measured so it is difficult for them to seek a particular outcome or misrepresent themselves. Even if they realize that a measurement like reaction time is important, it is hard for a player to fake a faster reaction time than one's true reaction time. Furthermore, the relationship between reaction time (or any other variable for that matter) and personality attributes is not necessarily or always one of positive or linear correlation, which makes it even harder to fake particular game-play outcomes. Games also potentially allow for very rich high-bandwidth interactions that greatly increase the potential amount of information that can be gathered in an interaction session. Because games have mass-market appeal and are well-suited for distribution over multiple devices and platforms, they also open the door to easily obtaining massive, web-scale amounts of data from large numbers of people that allows for deeper analysis and insight.

Thus, it is desirable to provide a system and method for extracting value from game-play data that addresses the above needs and it is to this end that the disclosure is directed.

### BRIEF DESCRIPTION OF THE DRAWINGS

FIG. 1 illustrates an example of a process of analyzing data that includes data generated from the playing of computer games;

FIG. 2 illustrates an example of a game from which data can be extracted and analyzed using the process in FIG. 1;

FIG. 3 illustrates an example of another game from which data can be extracted and analyzed using the process in FIG. 1;

FIG. 4 illustrates an example of the common aspects of games;

FIG. 5A illustrates an example of an implementation of a system for extracting value from game-play data that utilizes the process shown in FIG. 1;

FIG. 5B illustrates a computer system on which the game may be executed;

FIGS. 6 and 7 illustrate examples of a user interface for the system in FIG. 5A in an employment application;

FIG. 8 illustrates a high level diagram of the system;

FIGS. 9A and 9B illustrate an example of game feature values in two different data formats;

FIGS. 10 and 11 are charts with an example of a first type of game feature analysis by the system;

FIG. 12 illustrates a second type of game feature analysis using distribution charts; and

FIG. 13 illustrates a third type of game feature analysis using graph plots.

### DETAILED DESCRIPTION OF ONE OR MORE EMBODIMENTS

The disclosure is particularly applicable to the system and method for extracting value from game play data described below and it is in this context that the disclosure will be described. It will be appreciated, however, that the system and method has greater utility because: 1) the system may be implemented in different manners or using different computer architectures than the examples described below and the disclosure is not limited to the examples below; and 2) several different applications in which the system and method can be used are described below, but the system and method is not limited to those applications since the system and method for extracting value from game play data may be used in various different applications in which it is desirable to be able to extract value from game play data.

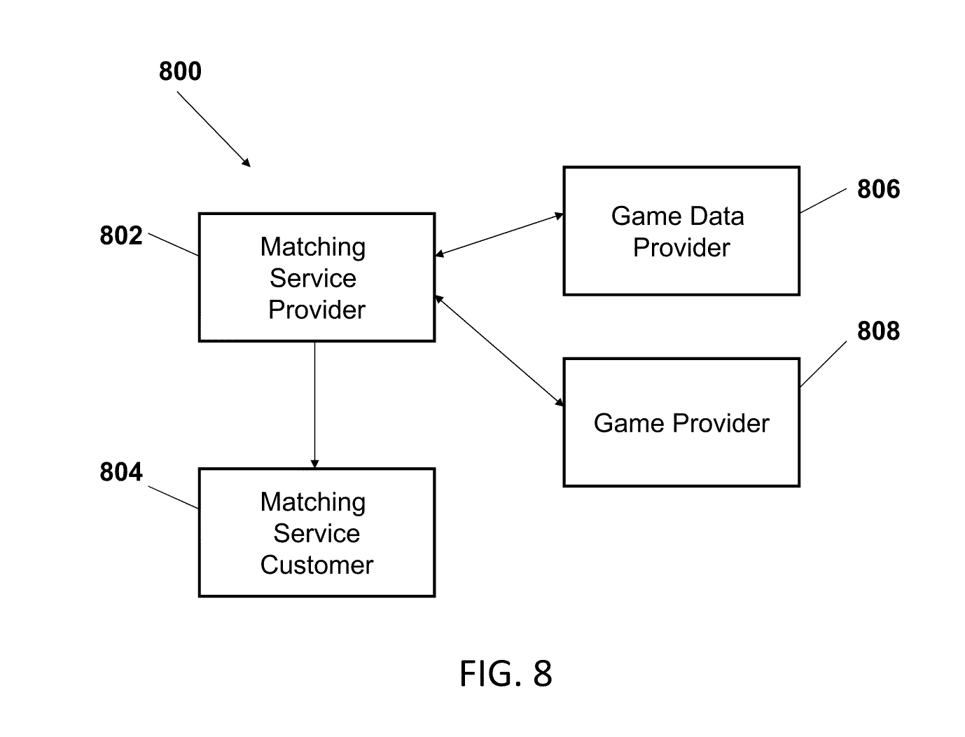

FIG. 8 illustrates a high level diagram of the system 800 that has one or more computer systems 802-808 used by different entities including one or more matching service provider systems 802, one or more matching service customer systems 804, one or more game data provider system 806 and one or more game data systems 808 that are interconnected together by links that may be wired or wireless and allow each of the systems to communicate with each other. In the illustration in FIG. 8, only a single system of each type is shown for clarity.

The system may involve one or more “matching service provider” (MSP) that is an entity that analyzes data that includes data from people playing computer games and provides data analysis results. The results can include information about people's personality traits, abilities, aptitudes, characteristics, competencies, dispositions, preferences, and skills; and can also include information that is useful for predicting behavior, performance, compatibility, fit, and preferences in the particular application domain area. The MSP could be a company, institution, individual, or a group thereof. In addition to the data from people playing computer games, the MSP may also use data that includes: questionnaire and survey responses; data collected from focus groups or other test groups or samples; biometric data; data from social networks, including social graphs, social network structure, and social networking intensity; data obtained from communication services; data obtained from other applications (APIs); data from text documents like resumes, profiles, emails, and performance reviews; statistical data from sources like performance ratings, SAT scores, GRE scores, GMAT scores, or other standardized and proficiency test scores; reviews of dating sites, reviews on product sites, and the like; socioeconomic data, including income, household, and zip code data; goods and services purchase history; content preferences, including movies and music; and the like. The game play data itself can be multi-faceted and includes response times; scores and achievements in the game; play session duration and frequency; metrics from the meta-game governing the game-play; metrics tracking or related to the decisions and behaviors of the player in the game or that of any player-controlled characters in the game; in-game text, visual, or voice chat and messages; data about player interaction with other players or users; data from inertial sensing devices, pressure sensitive buttons, keystrokes, joystick, mouse, or touchpad movements, cameras and microphones; sensors like accelerometers and gyroscopes; data from other peripherals, including motion sensors; gesture recognition data; location data; and discrete clickstream events.

The system also may involve one or more “matching service customers” (MSC) that is an entity that has interest in the MSP's data analysis results. The entity could be a company or institution, individual, or a group thereof. The interest could be a financial one in which a company sees a business value in the analysis results, it could be a public or governmental interest, an academic interest, an educational interest, research or policy interest, or it could be serving self-knowledge, self-insight, self-help or pure curiosity. There may be one or more different MSCs who may be interested in the same or different aspects of the analysis results.

The system also may involve one or more “game data provider” (GDPs) that is an entity that provides data from people playing computer games, that data being part of the input to the data analysis performed by the MSP. The GDP could be a company, an institution, or one or more individuals, or a group thereof. The game play data might be obtained from one of more games, each game provided by one or more possibly different “game providers” (GPs) that are separate companies, institutions, individuals, or a group thereof. Alternatively the GP and GDP could be the same entity. When the data is generated from more than one game or more than one GP, then there is some means to associate the same individual's data across different games. This could be done in whole or in part by some other company, or by a GDP, or by the MSP based on information provided by an individual, company or institution.

In the special case where the MSP, GDP, GP, and MSC are all separate companies, institutions or one or more individuals, then the MSP is a “middleman” between the GP, GDP and the MSC, and the disclosure is being used to create a market for the data analysis. The MSP might also be a department or component of the same company or institution as the MSC. These are however just some possibilities and the MSC, MSP, GP, and GDP could be the same company, institution, or one or more individuals. Any combination of two or three different companies, institutions, or one or more individuals, is possible.

The system also may involve a “data modeling culture” that is the more traditional view that the world can be described as a black box that has a relatively simple underlying model which maps from input variables to output variables (with perhaps some random noise thrown in). Science in general, and cognitive modeling in particular, has historically been based on this view.

The system also may involve an “algorithmic modeling culture” that has been championed more recently by researchers in biology, artificial intelligence, and other fields that deal with complex phenomena. It takes the view that a simple model cannot necessarily describe the world's “black box.” Complex algorithmic approaches (such as support vector machines or boosted decision trees or deep belief networks) are used to estimate the function that maps from input to output variables. There is no expectation that the form of the function that emerges from this complex algorithm necessarily reflects the true underlying nature. For example, see Breiman, L. (2001). “Statistical Modeling: the Two Cultures”. Statistical Science 16 (3): 199-215.

The system also may involve a profile and the system sometimes creates profile that is the result of the data analysis step. A profile may include information about a person's attributes, personality traits, abilities, aptitudes, characteristics, competencies, dispositions, personal preferences, and skills A group profile may combine the individual profiles of two or more persons. For example, a profile could include a set of measures of a person's general intelligence, conscientiousness, emotional intelligence, social abilities, etc. which are also shown in Appendix A which is incorporated herein by reference. Some or all of the components of a profile could be determined algorithmically from the data and might not always have an intuitive interpretation. For example, this could be the case if some components were automatically determined as linear combinations of other components.

The system may also include data regarding longitudinal changes in a person's profiles, and may also include predicted changes in the values of the components of a person's profile.

The system also may involve a matching distance. When comparing two or more profiles, the system defines a metric to define the distance between these profiles. The metric might a simple one in which each profile of n attributes is considered to be a point in some n-dimensional vector space and the distance between them is just the Euclidean distance in that space. Those skilled in the art would recognize that standard dimensionality-reduction algorithms such as principal component analysis (PCA) could be used to determine the k principal components of the profile vectors (where k is typically much smaller than n). In which case, the distance between each profile is the Euclidean distance in the possibly reduced k-dimensional space. Other possible distance metrics, on either the full dimensional space or some reduced dimensionality space, include the Manhattan norm, the p-norm, the infinity norm, the zero-norm, or the discrete time-warp distance (DTW).

The system also may involve explicitly desirable profiles. In particular, when the components of a profile have, or can be ascribed, intuitive semantics then an MSC can explicitly define desirable values for the components to create explicitly desirable profiles. For example, if one component is general intelligence and another is conscientiousness, then a desirable profile could be one that has high values on both of these components.

The system also may involve “independent desirability criterion” (IDC) that is some measure of an individual's desirability that either existed a priori to the application of the system or can be measured independently of the system. An IDC can include one or more people's belief in the desirability of the people or outcomes in the group, some external measure such as salary, or performance on a test, or a performance evaluation, information about qualifications, crowd-sourced desirability rankings, demonstrated preferences obtained from other sources of data, and the like, and IDC can also be comprised of the functional combination of one or more other IDCs. For example, an IDC could be a linear combination of one or more other IDCs.

The system also may include “independent desirable group” (IDG) that is a group of people that are labeled, possibly to some degree, as desirable according to some one or more IDCs. The degree of desirability can optionally be given probabilistic semantics by interpreting the desirability as the probability that someone would be considered desirable.

The system also may involve implicitly desirable profiles. If there is an IDC or IDG, then data from this group that includes data from people in the group playing games can be used to create one or more representative profiles for this IDC or IDG. These one or more representative profiles then represent implicitly desirable profiles. The desirable profiles can also be optionally compared to the degree of desirability of the people associated with the one or more representative profiles to determine the degree of desirability of those desirable profiles.

The distinction, therefore between an explicitly desirable profile versus an implicitly desirable profile is in how the profile is defined. The explicitly desirable profile is defined explicitly in terms of stated desirable criteria, whereas the implicitly desirable profile is defined implicitly as properties derived from a group of people designated as being desirable. Where the distinction in what follows is not important, an explicitly desirable profile or an implicitly desirable profile can simply be referred to as a desirable profile.

The notion of desirability is being used here in a technical sense since, depending on the application, the trait could actually be undesirable in normal speech. For example, in a medical diagnosis application, the “desirable” property the game is being used to uncover could be poor memory recall that might be indicative of an undesirable medical condition such as Alzheimer's. Similarly, in a dating application the “desirable” property that the analysis of the data is trying to uncover is the undesirable property in a partner of being selfish.

Note also that an IDG need not be the most desirable one. For example, an MSP might create some baseline profiles by collecting game play data from a group of people through a service like Craigslist and correlating data they provided about themselves with the profiles derived from the data that includes their game play data. For example, those who entered that they have a certain level of educational, creative or other achievement could be used to create an IDG from which a baseline desirable profile could be derived. These baseline profiles could provide some minimally attractive ones to an MSC and if they want better ones, then they could pay for the premium service in which the MSP utilizes data from an IDG that is much more desirable to the MSC. For example, an IDG made up of the MSC's top employees.

The system also may include a desirability classifier that can be built using machine learning techniques known to those skilled in the art from a training set that labels profiles with the degree of desirability according to some IDC. [For example, Professor Andrew Ng from the Stanford Computer Science Department regularly teaches a course on Machine Learning which provides an up-to-date overview of the subject. Many of the course materials, such as notes, are publicly available on the course website http://cs229.stanford.edu/ and video taped lectures from previous versions of the course are available on YouTube and iTunes. There is also a condensed version of the entire course publicly available at: http://ml-class.org] The degree of desirability is sometimes interpreted as a probability, it is also sometimes interpreted as binary membership in the desirable set or not. The resulting classifier, sometimes referred to as a model, can classify new profiles with a degree of desirability.

The system also may include a desirability search engine that allows an MSC to view profiles and search for desirable profiles. Searching can either be relative to some explicitly desirable profile, or some implicitly desirable profile, or using a desirability classifier. Those skilled in the art would recognize that a search engine could be built to facilitate searching for desirable profiles. Furthermore, the system may have a desirability recommendation engine that allows an MSP to provide a set of recommended profiles based on provided desirable profiles. Those skilled in the art would recognize that content-based recommendation or collaborative filtering methods can be used to build a recommendation engine, or use an existing one.

The system also may determine a degree of match. Whether a profile is found by searching or through a recommendation engine, there is sometimes an associated degree of match. For example, if a desirability classifier is used then there is sometimes a probability that the person would be associated with the corresponding profile and considered desirable.

The system also may include a big data cognitive psychology because the desirability classifiers, desirability search engine, and desirability recommendation engine are not necessarily amenable to easy human interpretation and can therefore represent an example of the application of the algorithmic modeling culture to determining desirable profiles. In the context of cognitive psychology and assessment services this approach is novel since they have traditionally not had access to huge amounts of data that lend themselves to the algorithmic modeling approach. They might also not have had the background in this area. It is the use of games as a data source that therefore provides some of the novelty for the disclosure, because games have mass appeal and can generate the huge amounts of data preferred by algorithmic modeling approaches.

Now, an example of the process and system for extracting value from game play data is described in more detail. In particular, the disclosure should be read in the most general possible form that includes, without limitation, the following: 1) references to specific structures or techniques include alternative and more general structures or techniques, especially when discussing aspects of the disclosure or how the disclosure might be made or used; references to the “preferred” structure or techniques generally mean that the inventor(s) contemplate using those structures or techniques, and think they are best for the intended application. This does not exclude other structures or techniques for the disclosure, and does not mean that the preferred structures or techniques would necessarily be preferred in all circumstances; 2) references to first contemplated causes and effects for some implementations do not preclude other causes or effects that might occur in other implementations, even if completely contrary, where circumstances would indicate that the first contemplated causes and effects would not be as determinative of the structures or techniques to be selected for the actual use; 3) references to first reasons for using particular structures or techniques do not preclude other reasons or structures or techniques, even if completely contrary, where circumstances would indicate that the first reasons or other structures or techniques are not as compelling. In general, the disclosure includes those other reasons or other structures or techniques, especially where circumstances indicate they would achieve the same effect or purpose as the first reasons or structures or techniques. After reading this application, those skilled in the art would see the generality of this description.

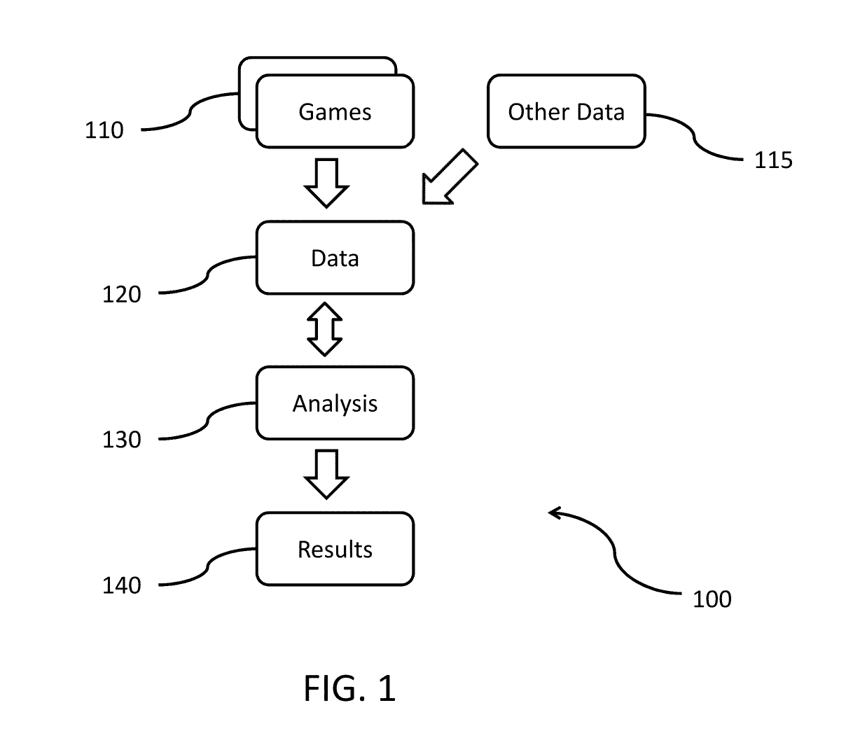

FIG. 1 illustrates an example of a process 100 of analyzing data that includes data generated from the playing of computer games. People play the computer games 110. The games are instrumented to record data 120. This kind of instrumentation is well known to those skilled in the art and is already widely used for debugging and improving games. The instrumentation potentially allows all aspects of a game play session to be captured in the data stream. Game data may be any data pertaining to a user's actions during a game. Game play data, on the other hand, may be players actions and decisions while actually playing the game. Thus, game play data can be multi-faceted and include discrete clickstream events; response times and times between responses or other actions; response accuracy; decisions and behaviors of the player in the game; scores and achievements in the game; play session duration and frequency; game events that arise from player actions, non-actions, or attempted actions; game events that arise from the game logic; metrics tracking or related to any player-controlled characters in the game; metrics from the meta-game governing the game-play; events or data from other players' actions in a multi-player game; data about player interaction with other players; data about interactions with other users who are not players in a synchronous or asynchronous multi-player game; in-game text, visual, or voice chat and messages; external factors such as the time of the day or proximity to external events; data from the Internet; hardware data; software data, such as browser used, screen size, and the like; data from sensors such as cameras and microphones that are accessible by the game; data from keystrokes and keystroke times; data from mouse, touchpad or joystick movements; data from other peripherals, including motion sensors and gesture recognition data; button presses, button press times, pressure-sensitive button pressure readings; data from inertial sensing devices and sensors like accelerometers and gyroscopes; and location data.

The data from the game might be stored locally on the same machine as the game is being played, or transmitted over the network and stored remotely. The data might also not be stored in any permanent storage at all, but might just be held in some computer memory long enough for some analysis to be performed. Those skilled in the art would recognize that there are many standard ways that can be used to instrument and collect data from games, all of which could be utilized by the disclosure.

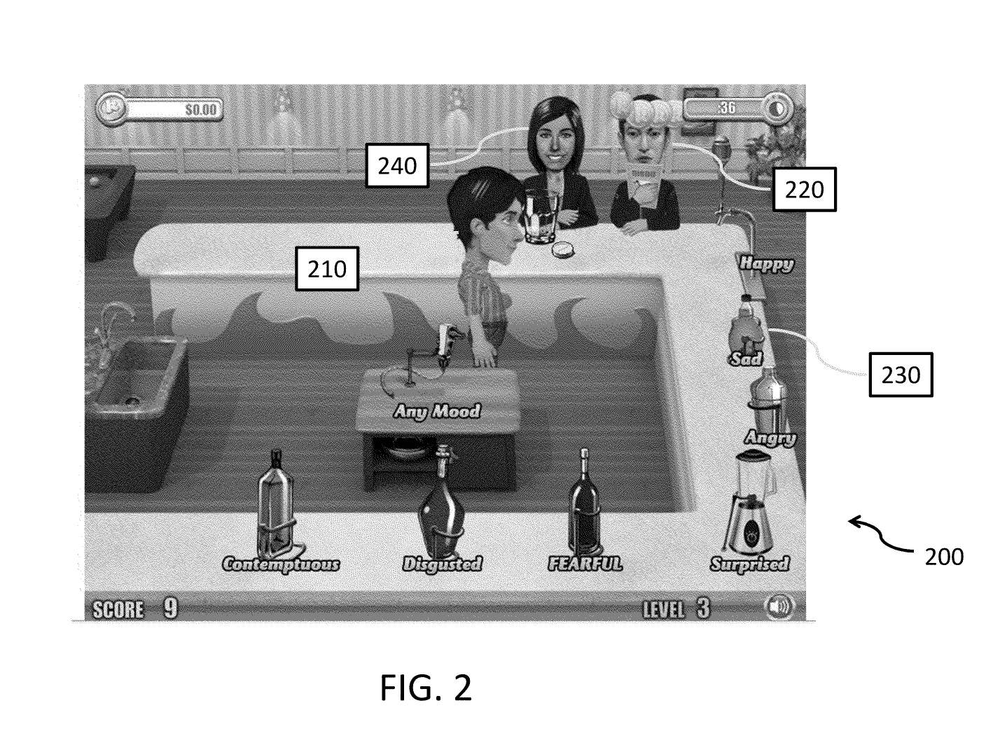

One novel aspect of the disclosure is that the games 110 might optionally include game play components and instrumentation designed solely to gauge or measure one or more specific attributes that are each a basic mental, intellectual, emotional or physical aspect of a player that can be gauged or measured (such as those listed in Appendix A.) For example, a game might include a task of recognizing emotions from facial expressions displayed by characters in the game as in the example game shown in FIG. 2. Players scoring well on such tasks might have the personality attributes that could make them, for example, good candidates for jobs involving customer service and other types of interaction with people, including security screening and collaborative teamwork. In addition to being designed to gauge or measure one or more specific attributes of the player, the games 110 may also be instrumented to provide game play data 120 as output. The game play data 120 may include game play data, which in turn may include information pertaining to the one or more attributes of the player that have been measured. For example, the game play data may include actual measurement information for the attributes that have been measured. Alternatively, the game play data may include playing information that indicates the actions and decisions made by the player while playing the game, and some context information that gives meaning to the actions and decisions made by the player during the game. For example, the playing information may indicate that the player chose not to perform an action, and the context information may indicate that the choice took place at a point in the game where the player had to decide between stealing a car or not. By interpreting the playing information along with the context information, some measurement information can be derived for an attribute of the player. In this example, the attribute is “lawfulness”, and the measurement information is that, at least in one instance, the player chose to be lawful.

Using the attribute measurement information contained in or derived from the game play data, analysis 130 can be performed, and a profile can be derived for the player. This profile may contain, for example, an assessment of one or more personality traits of the player, an assessment of one or more personal preferences of the player, an assessment of one or more aptitudes of the player, etc.

There is usually some way to associate the data obtained from a game with a person's identity. One well-known way to do this is to have the player login with a username and password prior to them starting to play the game. Other possibilities include using a cookie or authentication token already present on the game-playing device. For example, if someone is already logged in to a social networking site like Facebook, then the identity of the player can be inferred from the social networking site. Consoles and mobile devices might also have platform wide mechanisms for identifying players that can be used. Other possibilities include facial recognition from camera, explicit or implicit sign in with voices using microphones, signatures on touch sensitive devices, characteristic data from inertial sensors or other sensors. Those skilled in the art would recognize that there are wide varieties of well-known mechanisms for associating game play data with an individual. Those skilled in the art would recognize that most aspects of the system and method described above apply not only to individuals, but also to teams and groups.

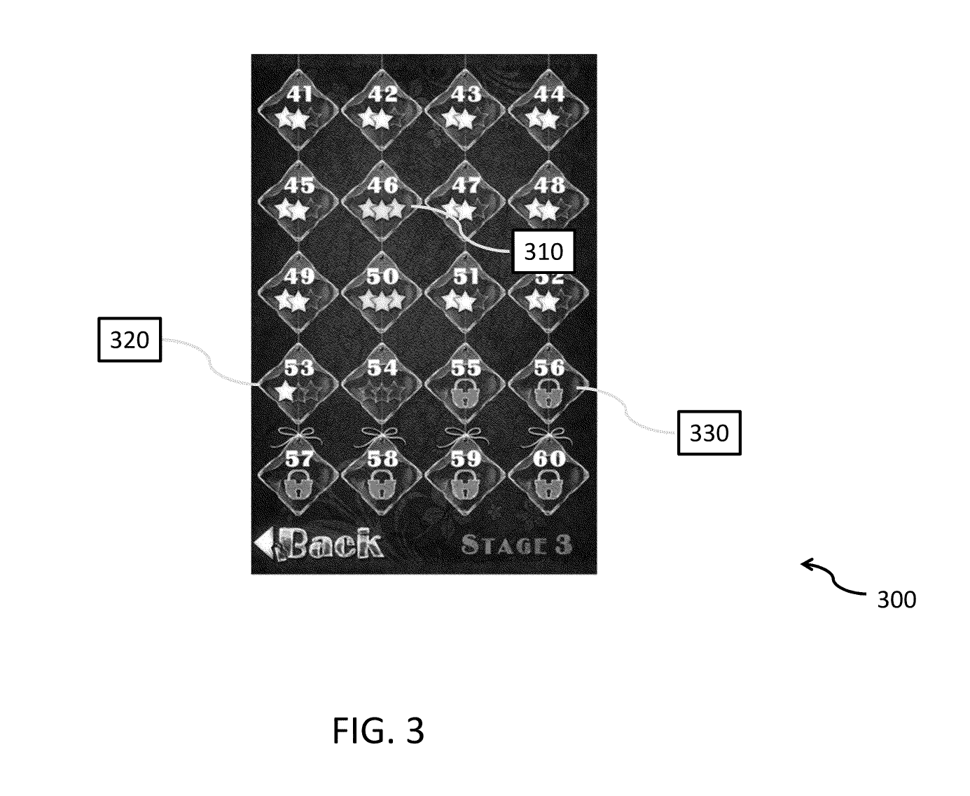

The method in FIG. 1 may also capture game play data from two or more different games (at least a first game and a second game) being played by the player. The first game measures/is used to gather game play data about a first set of attributes of the game player. The second game, which is different from the first game (such as the difference between FIGS. 2 and 3), measures/is used to gather game play data about a second set of attributes of the game player. The first and second set of attributes may be the same or may be a different set of attributes. In any event, both set of game play data may then be used by the analysis process 130 described below.

In addition, the method may involve a group of players playing a game and generating game play data from the group of players. The analysis process 130 described below may then generate a profile for the group of players based on the game play data. In deriving the group profile, the method may use two games (as above) and derive a profile of a first player from the first set of game play data and then derive a profile of a second player from the second set of game play data and then derive the group profile from the first and second profiles.

Apart from game play data, there are many other sources of data 115 that can optionally be utilized by the disclosure. This includes questionnaire and survey responses data; statistical data from sources like performance ratings, SAT scores, GRE scores, GMAT scores, or other standardized and proficiency test scores; data from text documents like resumes, profiles, emails, and performance reviews; data collected from focus groups or other test groups or samples; data from social networks on friends, social graphs and social network structure data, and social networking interaction intensity; data obtained from communication services, such as email, chats, and other services; data obtained from other applications (APIs); reviews of dating sites, reviews on product sites, and the like; goods and services purchase history; content preferences, including movies and music; biographical data, including birth data, number of friends, interests, previous jobs, job performance reports, salary, income, demographic and socioeconomic data, including income, household, and zip code data; and biometric data.

The data 120 from the game 110 and possibly other sources 115 is then analyzed 130 and may result in a profile for the player of the game. The data may or may not need to be stored in persistent storage. The results of the analysis 130 may yield intermediate results that may optionally be stored (persistently or not) as additional data 120 that can be used for additional analysis 130. The profile for the player may include an assessment for one or more personality traits of the player, one or more personal preferences of the player, one or more aptitudes of the player, etc.

As part of the analysis 130, the game play data outputted by the game 110 may be processed to derive measurement information for the one or more attributes measured by the game 110. The one or more attributes may be correlated to one or more personality traits, one or more personal preferences, one or more aptitudes, etc. Then, based at least in part upon the measurement information for the one or more attributes, one or more assessments may be made for one or more personality traits of the player, one or more personal preferences of the player, one or more aptitudes of the player, etc. The one or more assessments may then be included in the profile for the player.

To illustrate how the analysis 130 may proceed, reference will be made to several examples. As a first example, the game play data may indicate that the player had three instances in which the player had to decide between doing something that is lawful and something that is unlawful, and chose in all three instances to take the action that is lawful. From this game play data, measurement information for the “lawfulness” attribute of the player can be derived. The “lawfulness” attribute may be correlated to the higher level personality trait of “moral”. Then, based on the measurement information for the “lawfulness” attribute of the player, an assessment can be generated for the player that indicates that the player is moral.

As another example, the game play data may indicate that the player had three instances in which the player chose to take a risky route rather than a conservative route. From this game play data, measurement information for the “risk” attribute of the player can be derived. The “risk” attribute may be correlated to the higher level personal preference of “excitement”. Then, based on the measurement information for the “risk” attribute of the player, an assessment can be generated for the player that indicates that the player has a personal preference for excitement.

As a further example, the game play data may indicate that the player recognized numerous emotions correctly. From this game play data, measurement information for the “emotion recognition” attribute of the player can be derived. The “emotion recognition” attribute may be correlated to the higher level aptitude of “perceptive”. Then, based on the measurement information for the “emotion recognition” attribute of the player, an assessment can be generated for the player that indicates that the player has an aptitude for being perceptive.

The results of the analysis 140 are then presented to an MSC. As previously stated, the MSC might be the same person whose game play data was analyzed or it could be someone else. Depending on the application, the results 140 could include variety of predictions and recommendations, including job, role, and company recommendation; career and other professional recommendations; school, college, university, curriculum, or other educational, training, re-training, or personal development recommendation; job candidate selection recommendations; promotion and leadership recommendations; team or group composition recommendation; goods, products, and service recommendation; content recommendations; advertising recommendations; investment and financial products recommendations, including investment management services, investment products, insurance and risk-management products, mortgage, credit and other debt products recommendations; partner or mate recommendation; and diagnostic, treatment and medical, mental, psychological and other health-related recommendations.

FIG. 2 illustrates an example of a game 200 from which data can be extracted and analyzed using the process in FIG. 1. The game may be known as the Happy Hour game. The Happy Hour game is a game that can be played on the web that has been specially crafted to determine a person's personal attributes, including abilities, aptitudes, characteristics, competencies, dispositions, traits, and skills, and their respective properties. The game player controls a bartender character 210 and one or more customers 220 that come into the bar. When the player clicks on a customer 220 the customer reveals a facial expression and the player must click on a drink 230 that corresponds to the player's perception of the customer's emotion. For example, if the customer looks happy then the player should click on the happy drink. The game can be made more difficult by various techniques including making the emotions subtler, partially masking the customer's face, increasing the number of customers showing up at once, and decreasing the time available to choose the correct drink. Aside from emotion recognition abilities, the game measures numerous other attributes including multi-task abilities, time management abilities, problem solving abilities, optimal strategic thinking, and several personality characteristics, including risk tolerance and dispositions. The environment of the game (e.g., the player being a bartender serving drinks) provides a context of the game player's action and gives meaning to the actions (for example, which attribute of the player is being illustrated by the particular action.) The analysis process 130 then derives the measurement information of the attributes of the player of the game.

1. Attributes measured in Happy Hour include:
Social and Emotional Cognition
   Emotion recognition ability
   Emotional intelligence
   Empathy
   Social bias
Standard Cognition
   Processing speed
   Learning rate
   Implicit learning
   Working memory
Strategy
   Problem-Solving
   Prioritization
Personality
   Conscientiousness/“Grit”
   Agreeableness
   Intellect
   Neuroticism
   Growth vs. Fixed Mindset
   Achievement orientation
Economic Cognition
   Risk-aversion
   Impulsivity
      The kind of results that can be obtained from the Happy Hour game include:
Social and Emotional Cognition
   Game measures of emotion recognition ability correlate with emotion recognition, empathy, and intelligence as well or better than existing measures
Standard Cognition
   In-game processing speed and strategy correlate with SAT scores
   In-game information processing ability, emotion recognition ability, and strategy correlate with GPA
Strategy
   Differential use of a variety of in-game use of strategy/problem-solving skills can be used to categorize players; players in different categories differ in personality, mindset, achievement, and impulsivity
   Prioritization strategies correlate with SAT and GPA
Personality
   Emotion recognition ability strategy correlate with conscientiousness
   Emotion recognition ability and motivation correlate with agreeableness
   In-game processing speed and strategy correlate with intellect
   Adoption of certain in-game strategies correlates with mindset type
Economic Cognition
   Strategy use correlates with impulsivity

Thus, the analysis process 130 may then correlate the attributes to one of personality traits, personal preferences and aptitudes of the player of the game as shown in the list above. The analysis process 130 may also assess the personality traits, personal preferences or aptitudes of the game player based on in part of the attributes determined/measured based on the game play.

These results are only from some preliminary analysis performed on a relatively small sample size and are mostly simple zero-order correlations used here primarily for illustrative purposes. The disclosure can discover more and stronger relationships from the analysis of data from large, diverse samples. In particular, given a workplace or other samples with varied levels of organizational performance or varied values of other outcome variables, more targeted predictive relationships are possible.

The system and process may use many different games and game concepts that are crafted to measure various personal attributes, including abilities, aptitudes, characteristics, competencies, dispositions, traits, and skills, and their respective properties. Another example is a game that allows a player to inflate a water balloon. The more the balloon inflates, the greater the risk it will burst. But the bigger it is the more effective it is at being dropped on some enemies to scare them away from some desirable resource. The game therefore includes an explicit measure of risk tolerance, including risk-aversion and risk-seeking preferences and behaviors.

FIG. 3 illustrates an example of another game 300 from which data can be extracted and analyzed using the process in FIG. 1. In this example, the game is an iPhone game called Amazing Breakers. Like many games, the game includes levels and achievements. The better the player does on each level the more stars s/he receives. Receiving one star 320 is sufficient to unlock one or more subsequent levels 330. Players will therefore play in a wide variety of ways. For example, some players will not proceed to the next level until they have 3 stars 310 on all previous levels. Some players will eventually give up if the level is hard and proceed anyway. Other players will never worry about getting 3 stars before proceeding. Other players may return to previous levels to get more stars. Each of these different meta-game behaviors, and their degree, and the relative timings and frequency are potentially valuable in determining traits and abilities of players. Other data that might be relevant are the types of games genres that people chose to play, or the opponents and companions they chose to play against and alongside.

Although no one is aware of any games that have been instrumented for this kind of analysis, the figure is included to show that many, if not all games are amenable to being used to determine something about a person's abilities and traits.

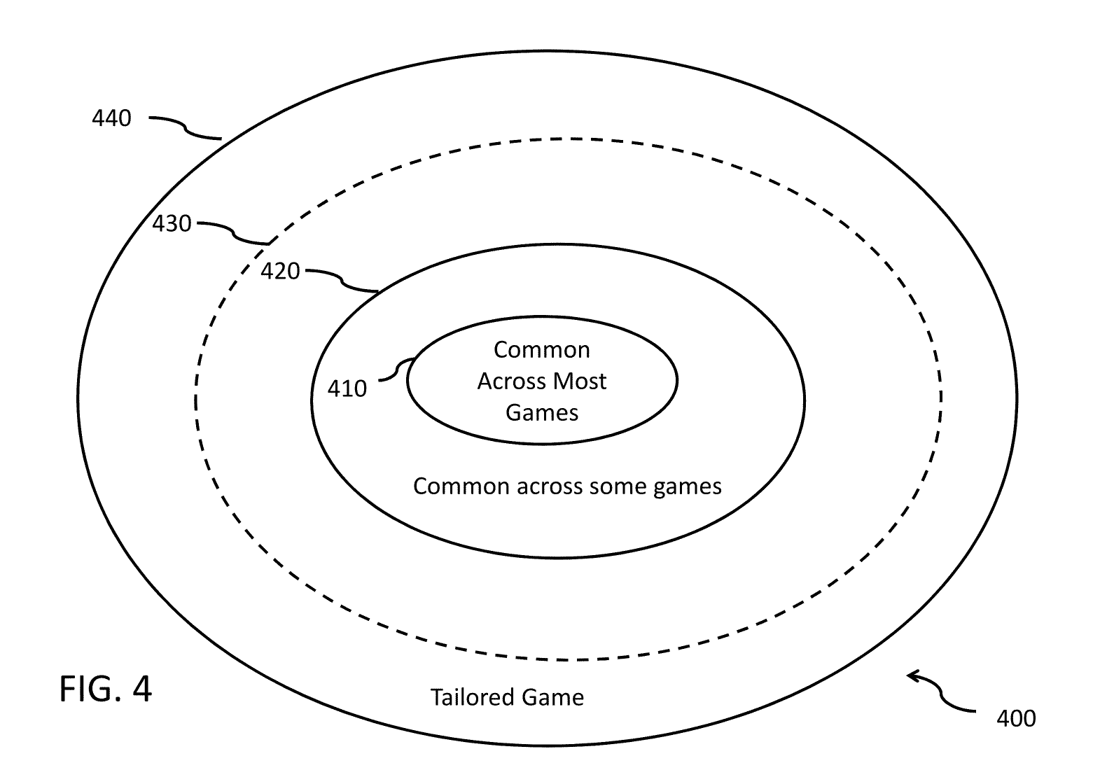

FIG. 4 illustrates an example of aspects 400 that are common across many games 410. Examples include reaction times, meta-game behaviors (like those described in the explanation of FIG. 3). The system may include a software development kit (SDK) that could be made available to “game developers” (GDs) based on these common aspects. The SDK could be a library that GDs download and incorporate into their game or just an online API that the developer can call with appropriate parameters. Any GD can then take the SDK and incorporate it into their own game, potentially in a self-service manner without the need to involve the MSP in the SDK integration process. As part of the game development process, the GD creates a game that gauges one or more specific attributes of the player playing the game, and collects information pertaining to the one or more specific attributes.

To create the game, the GD may write computer code that, when executed by one or more processors, causes the one or more processors to implement functionality that interacts with the player to gauge the one or more specific attributes of the player. In addition, the GD may instrument the game such that the game provides information pertaining to the one or more attributes as output. The information outputted by the game may include game play data, which may include measurement information for the one or more specific attributes of the player. Alternatively, the game play data may include playing information that indicates the actions and decisions made by the player while playing the game, and context information that gives meaning to the actions and decisions made by the player. From the playing information and the context information, measurement information for the one or more attributes can be derived.

Data from that GD's game can then be provided to the MSP for analysis. Other attributes like risk aversion might be less common across games 420 and may initially not be part of the SDK, but instead require the MSP to help integrate the required instrumentation into the GD's game. Over time, patterns or commonalities might emerge that allow attributes to migrate to the self-service SDK. There are potentially many layers 430 to the commonalities across games. At the outer layer 440 are games that are specifically crafted to measure certain abilities and traits. They may still use the SDK for the common parts, but might require close collaboration with the MSP and GD.

The system may also include an SDK for the results. That is, the results could provide information about traits and abilities from game play data and some third-party could interpret and further analyze those results in some domain without the need for the disclosure to necessarily be further involved. The disclosure could in effect be used as a service that is fed data that includes game play data and returns information on the corresponding people's traits and abilities that is then used for predictions, recommendations and matching in other applications. For example, such data could be passed to Taleo, LinkedIn, Facebook, oDesk, TaskRabbit, AirBnB, eHarmony, Google AdSense, Google Shopper, Google Search, Amazon, eBay, App Store, American Express, YouTube, Netflix, iTunes, and other applications.

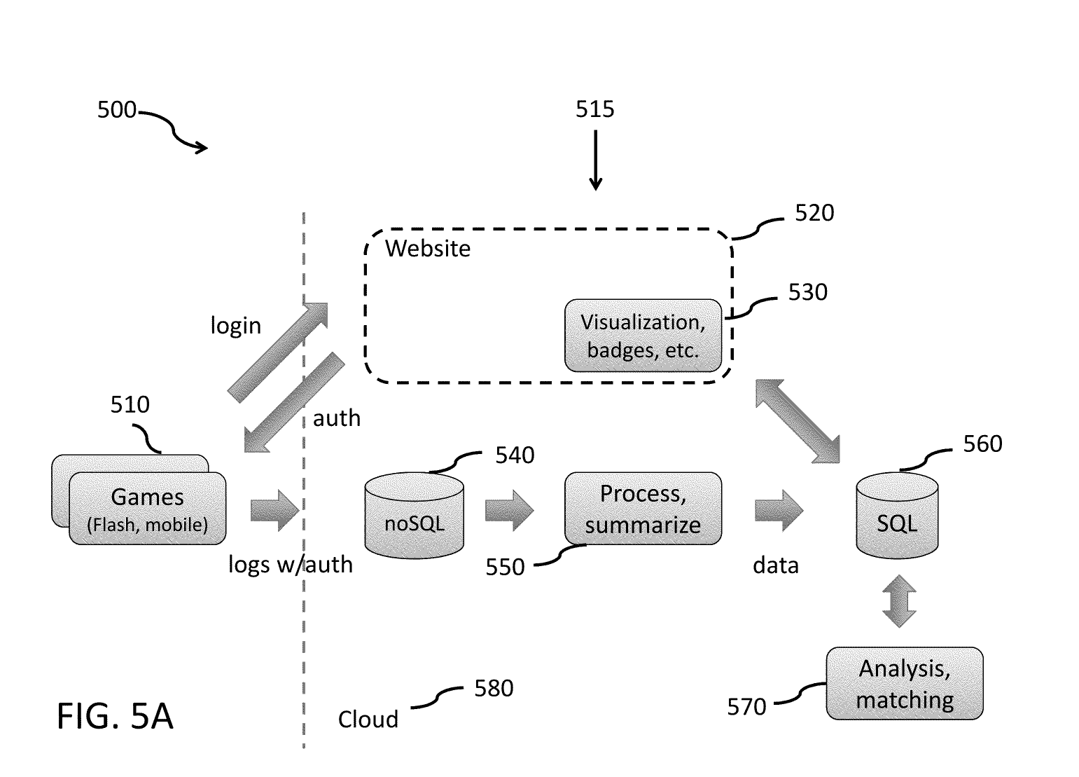

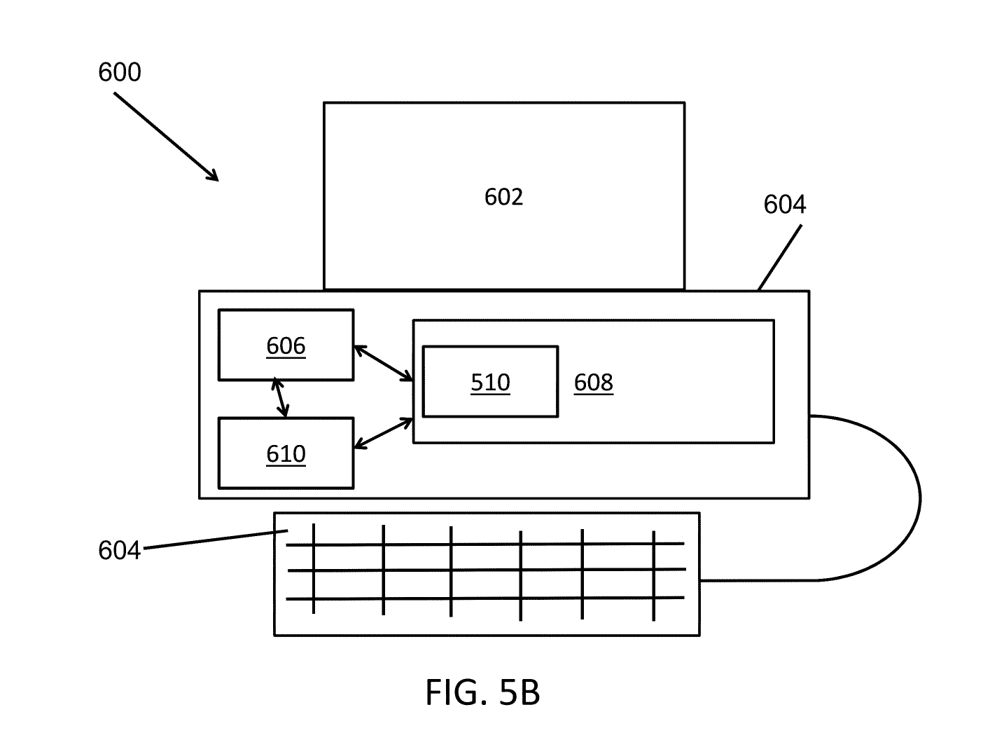

FIG. 5A illustrates an example of an implementation of a system 500 for extracting value from game play data that utilizes the process shown in FIG. 1. As before, people play games 510 by first logging in either directly to some website or mobile application 520 or indirectly in the game itself. The games may be played on one or more computing devices and each computing device may be a processor based system with memory, input/output devices and a display system to interact with and play the game. For example, each computing device may be a personal computer, a tablet computer, a terminal device, a smartphone device (such as the Apple iPhone, Android based devices, etc.) and the like. The result of logging in is that the game receives some token or session identifier that is used to tag the data so that it is associated with the person playing the game. Those skilled in the art would recognize that logging in is only one possible way to associate the data. Other possibilities include a unique identifier on the hardware used to play the game, or biometric data, or cookies or tokens from other sites like Facebook.

The data is then transferred over the network to some storage 540. A system for data extraction 515 includes the storage 540 as well as the other components/units/modules on the left side of the dotted line in FIG. 5. In one implementation, the system 515 may be one or more computing resources and each component/unit/module may be a plurality of lines of computer code that are executed by the one or more computing resources to implement the functions and operations described below. The one or more computing resources may be one or more server computers, one or more cloud computing resources or a stand-alone computer if the system 515 is implemented as a stand-alone system. In one implementation, the system may use JSON or XML to transfer the data, but other text or binary formats could be used instead. For example, here is a snippet of a JSON “log message” used to record an endgame event that summarizes the player's performance in the game:

{

“event”: “endGame”,
“logMessageNumber”: 157,
“totalMisclicks”: 4,
“sessionHash”: “1327511032:f6471ed69e5d8f4df5b3aac25ac”,
“totalTips”: “$3.00”,
“totalClicks”: 34,
“emotionStats”: {

“Happy”: {

“totalServed”: 2,
“averageTimeToServeCustomer”: 3709.25,
“averageTimeToSelectDrink”: 2478

}

}

},

A noSQL database is sometimes used because of it's ability to scale to massive amounts of data but those skilled in the art would recognize that there are many possibilities including log files or other SQL databases. The raw data is then sometimes processed 550 into a format that is easier to work with. For example, individual log messages that indicate the reaction time for various game events or the same event at different times, could be summarized to give statistics such as the mean, median, minimum, maximum reaction times and could include the standard deviation, confidence intervals, and percentiles. This summarized data could be stored in a database. In one embodiment, a traditional SQL database 560 may be used for the summary data so that they can quickly perform joins and other standard database manipulations. But a noSQL database or other kind of persistent storage could be used. In some applications, no persistent storage might be needed at all and all the databases shown in the figure could just be replaced by storage of temporary results in computer memory.

More in depth analysis 570 on the raw logs, or on the summary data can then be performed. For example, principal component analysis (PCA) could be used to find axes or factors that best represent the data. Independent component analysis (ICA) could also be used to uncover independent components in the data.

Data from different people could then be compared using various distance metrics known to those skilled in the art. For example, either in some vector space directly defined by the data components or in some reduced dimensionality space defined by the principal components of a PCA. Some other examples of well know potentially relevant techniques include: independent component analysis (ICA), linear discriminant analysis (LDA), quadratic discriminant analysis (QDA). In addition, clusters of people could be found using techniques known to those skilled in the art including: k-means, quality thresholding (QT), mixtures of Gaussians fit with EM.

Additional analysis 570 can sometimes include recommending people or products based on rating matches or suggested matches. For example, in a dating application if a suggested match led to an actual date, then the date experience could be rated and used as feedback to the matching process. Even without an actual date, people can rate the desirability of the suggested matches by looking at additional information on the suggested dates, such as their photographs or personal information. An analogous approach applies to suggestions of potential employees for a job where the suggestions can be rated based on resumes, or from additional testing such as interviews or exams, or from actual on the job performance if they are hired. Products and services can also be rated based on experience of the product or service or anticipated experience.

Techniques known to those skilled in the art for building such recommendation engines include content-based recommendations. Simple approaches use the average values of the rated item vector while other sophisticated methods use machine learning techniques such as Bayesian Classifiers, cluster analysis, decision trees, artificial networks in order to estimate the probability that the user is going to like the item.

Collaborative filtering techniques are another well-known class of techniques for building recommendation engines and a wide variety of implementation details can be found on Wikipedia and the references contained therein. Further details of the system and an example of the implementation of the system is shown in Appendices A and B that are incorporated into the specification herein by reference.

It is important to recognize that a potentially important class of MSCs are individuals. That is, individuals can be given access to their profiles, or full or partial ownership of their profiles. Or they can be given access to or ownership of information derived from the profiles. For example, an individual whose profile indicates that they have high emotional intelligence, or are conscientious, could be given a badge that they could display on their own web page, in their resume, on a dating site, or some social media site like Facebook, or LinkedIn, or include in email. The badge could have dynamic elements, for example, a component to indicate the current percentile they belong to, or it could be static, or there could be variations with different levels, such as a badge with three stars. The profiles, or representations of the profiles could then be searchable from either general-purpose search engines, or site-specific search engines. Individuals could also be given a dynamic or static badge that indicates their profile's proximity to another desirable profile.

It is sometimes useful to give superfluous badges, or obscure aspects of the profile so that individuals do not try to exploit knowledge of profiles to give the perception of abilities that they might not possess. For example, a badge or profile elements such as “fast learner” could encourage people to play a game under a pseudonym or false identity until they had mastered it. Then playing as themselves they would initially play below their full capability and then quickly allow themselves to play at their full capability. Thus giving the inaccurate appearance of having learned very quickly. Therefore any component of a profile that measures learning rate might be kept hidden and there might be no “fast learner” badge. Instead there might be superfluous badges such as “first person to get over 300 on this Tuesday” so that people were not quite sure what aspects of their game play were important and which were not. Another way is, as mentioned above, to give individuals a badge that indicates their profile's proximity to another desirable profile, without actually revealing the components that make up the individual's profile or those of the desired profile.

FIG. 5B illustrates a computer system 600 on which a game may be executed. The computer system may be any computing device with one or more processors, memory, a display and connectivity such that a user can interact with the game and game play data may be captured. For example, each computing system may be a smartphone device (Apple iPhone, Android based device, etc.), a tablet computer, a laptop computer, a personal computer, a game console and the like. For example, the system computer may be a personal computer system as shown in FIG. 5B that has a display 602 and chassis/body 604 that houses at least processing device 606, a memory 608 and a persistent storage device 610 which are all well known elements of a computer. The game 510 may be loaded into the memory 608 from the persistent storage device 610 as shown in FIG. 5B and then executed by the at least processing device 606. In this example, the game and the game play analysis system are each a plurality of lines of computer code. In addition, the system that analyzes the game play data may also be loaded into the memory and then executed by the at least processing device 606. In addition to the computer system in FIG. 5B, the game and/or the game analysis system may be stored on and/or executed from a computer readable medium such as an optical disk, flash memory device, memory in a computer and the like. Furthermore, the game and/or game play data analyzed may be downloaded over a network or may be delivered as software as a service.

Game Features

Returning to the Happy Hour game whose user interface is shown in FIG. 2, there are game features (or game variables) that are values calculated about the game play session. Some of the features are direct measurements of values in the game and other game features are computed from those values. The table below describes some examples of game features from the “Happy Hour” game. Other games may have different game features that may be used by the disclosed system and method and the system and method is not limited to any particular game or any particular game features.

In the game features for the “Happy Hour: game, the features generally follow the format of being computed for each level of the game (this particular instance of the game had 10 levels) and then a feature that summarizes the feature for the whole game session. Depending on the feature, the summary can be one or more of a sum, a mean, a median, a standard deviation, a min, a max, or any other statistical or numerical summarization known to those skilled in the art of statistics, data-mining and machine learning. In the explanation column, some of the feature semantics are described while others are obvious from their name or simply left un-explained in the interests of brevity, but the name may still allude to their semantics and their presence indicates something of the range of features that can be computed. The names of the features are chosen for ease of human consumption and are somewhat arbitrary. For example, a feature like “tips_level1” could be called “tipsLevel1”, or “tipsGainedFromLevel_{—}1”, etc. For most automated analysis processes, such as those used in the system, the name is unimportant and could equally as well be “feature05” or any other unique identifier.

| Game Feature Name | Explanation |
|---|---|
| level_selection_level1 | Which level of the game was played first |
| level_selection_level2 | Which level of the game was played second |
| level_selection_level3 | Etc. |
| level_selection_level4 | |
| level_selection_level5 | |
| level_selection_level6 | |
| level_selection_level7 | |
| level_selection_level8 | |
| level_selection_level9 | |
| level_selection_level10 | |
| bug_duration_secs_level1 | For each level, how many of seconds of game play experienced |
| bug_duration_secs_level2 | bugs that might have affected the data collected were |
| bug_duration_secs_level3 | there. This data can be used, for example, to exclude |
| bug_duration_secs_level4 | or re-weight data from levels that exceed some threshold. |
| bug_duration_secs_level5 | |
| bug_duration_secs_level6 | |
| bug_duration_secs_level7 | |
| bug_duration_secs_level8 | |
| bug_duration_secs_level9 | |
| bug_duration_secs_level10 | |
| bug_duration_secs_total | Total seconds of game play possibly affected by bugs |
| missing_logs_level1 | For each level, how many log messages were failed to |
| missing_logs_level2 | be received by the server/database. |
| missing_logs_level3 | |
| missing_logs_level4 | |
| missing_logs_level5 | |
| missing_logs_level6 | |
| missing_logs_level7 | |
| missing_logs_level8 | |
| missing_logs_level9 | |
| missing_logs_level10 | |
| missing_logs_total | Summary of missing logs total for session |
| tips_level1 | These features measure the amount of tips collected by |
| tips_level2 | the player across levels and for the whole game. They |
| tips_level3 | represent an example of a feature that directly measures |
| tips_level4 | a property maintained and displayed in the game itself. |
| tips_level5 | |
| tips_level6 | |
| tips_level7 | |
| tips_level8 | |
| tips_level9 | |
| tips_level10 | |
| tips_total_1to9 | |
| tips_total_1to10 | |
| ER_acc_level1 | These features measure how accurately a player |
| ER_acc_level2 | recognizes emotions of characters shown in the game. |
| ER_acc_level3 | That is, ER_acc stands for “emotion recognition |
| ER_acc_level4 | accuracy”. |
| ER_acc_level5 | |
| ER_acc_level6 | |
| ER_acc_level7 | |
| ER_acc_level8 | |
| ER_acc_level9 | |
| ER_acc_level10 | |
| ER_acc_mean | |
| ER_acc_controlled_for_difficulty_level1 | These features are an example of a feature computed |
| ER_acc_controlled_for_difficulty_level2 | from game play data after the fact. The game itself may |
| ER_acc_controlled_for_difficulty_level3 | have no representation of the relative difficulty of |
| ER_acc_controlled_for_difficulty_level4 | recognizing different emotions. But this information is |
| ER_acc_controlled_for_difficulty_level5 | combined with the game play data during analysis to |
| ER_acc_controlled_for_difficulty_level6 | create this new feature that is the accuracy of |
| ER_acc_controlled_for_difficulty_level7 | recognizing emotions presented in the game attenuated |
| ER_acc_controlled_for_difficulty_level8 | by the difficulty of recognizing those particular |
| ER_acc_controlled_for_difficulty_level9 | emotions. For example, it is easier for most people to |
| ER_acc_controlled_for_difficulty_level10 | recognize happiness than contempt. The relative |
| ER_acc_controlled_for_difficulty_mean | difficulty of emotions to recognize can be decided a |
| | priori based on other information, or computed |
| | empirically by looking at the aggregate performance of |
| | multiple players across multiple game play sessions. |
| | For example, if it empirically turns out that recognizing |
| | contempt is twice as hard as recognizing happiness, |
| | then that difficulty factor can be used to attenuate the |
| | feature calculation. This then controls for comparing |
| | performance of players who may have done badly, or |
| | well, simply based on the set of emotion recognition |
| | tasks that happen to be presented to them. Players |
| | typically get different sequences of tasks because the |
| | tasks are sometimes selected in the game based on the |
| | output of a random number generator. |
| ER_acc_controlled_for_difficulty_regression_on_gameplay_time | This feature is another example of a feature who's |
| | value is derived from other features. It measures the |
| | rate of change of the attenuated emotion recognition |
| | accuracy as a function of game time. That is, some |
| | players might improve (or deteriorate) at different rates |
| | as the game proceeds. |
| ER_correct_RT_ms_level1 | This feature measures the reaction time (ms stands for |
| ER_correct_RT_ms_level2 | milliseconds) for cases where the player guessed the |
| ER_correct_RT_ms_level3 | correct emotion. |
| ER_correct_RT_ms_level4 | |
| ER_correct_RT_ms_level5 | |
| ER_correct_RT_ms_level6 | |
| ER_correct_RT_ms_level7 | |
| ER_correct_RT_ms_level8 | |
| ER_correct_RT_ms_level9 | |
| ER_correct_RT_ms_level10 | |
| ER_correct_RT_ms_mean | |
| ER_correct_RT_ms_controlled_for_difficulty_level1 | As above, but attenuated for difficulty. |
| ER_correct_RT_ms_controlled_for_difficulty_level2 | |
| ER_correct_RT_ms_controlled_for_difficulty_level3 | |
| ER_correct_RT_ms_controlled_for_difficulty_level4 | |
| ER_correct_RT_ms_controlled_for_difficulty_level5 | |
| ER_correct_RT_ms_controlled_for_difficulty_level6 | |
| ER_correct_RT_ms_controlled_for_difficulty_level7 | |
| ER_correct_RT_ms_controlled_for_difficulty_level8 | |
| ER_correct_RT_ms_controlled_for_difficulty_level9 | |
| ER_correct_RT_ms_controlled_for_difficulty_level10 | |
| ER_correct_RT_ms_controlled_for_difficulty_mean | |
| ER_correct_RT_ms_controlled_for_difficulty_regression_on_gameplay_time | Another regression on game play time of above feature. |
| ER_guesses_per_customer_level1 | |
| ER_guesses_per_customer_level2 | |
| ER_guesses_per_customer_level3 | |
| ER_guesses_per_customer_level4 | |
| ER_guesses_per_customer_level5 | |
| ER_guesses_per_customer_level6 | |
| ER_guesses_per_customer_level7 | |
| ER_guesses_per_customer_level8 | |
| ER_guesses_per_customer_level9 | |
| ER_guesses_per_customer_level10 | |
| ER_guesses_per_customer_mean | |
| ER_guesses_per_customer_regression_on_gameplay_time | |
| any_mood_proportion_level1 | Any mood is an option players can pick in this game |
| any_mood_proportion_level2 | when they don't know the emotion or don't want to |
| any_mood_proportion_level3 | spend time figuring it out. Use of the any mood option |
| any_mood_proportion_level4 | is another source of potential individual differences. |
| any_mood_proportion_level5 | |
| any_mood_proportion_level6 | |
| any_mood_proportion_level7 | |
| any_mood_proportion_level8 | |
| any_mood_proportion_level9 | |
| any_mood_proportion_level10 | |
| any_mood_proportion_mean | |
| any_mood_proportion_regression_on_gameplay_time | |
| mean_simultaneous_dishes_carried_to_sink_level1 | This is an example of a feature that measures player |
| mean_simultaneous_dishes_carried_to_sink_level2 | efficiency in the task of carrying orders to customers in |
| mean_simultaneous_dishes_carried_to_sink_level3 | the game. Some players never figure out that they can |
| mean_simultaneous_dishes_carried_to_sink_level4 | carry more than one customer order at a time, some |
| mean_simultaneous_dishes_carried_to_sink_level5 | figure it out later, some earlier, some figure it out and |
| mean_simultaneous_dishes_carried_to_sink_level6 | subsequently stop doing it, etc. Some do it a lot, some |
| mean_simultaneous_dishes_carried_to_sink_level7 | very little. |
| mean_simultaneous_dishes_carried_to_sink_level8 | |
| mean_simultaneous_dishes_carried_to_sink_level9 | |
| mean_simultaneous_dishes_carried_to_sink_level10 | |
| mean_simultaneous_dishes_carried_to_sink_mean | |
| mean_simultaneous_dishes_carried_to_sink_regression_on_gameplay_time | |
| proportion_sequence_breaking_actions_level1 | This feature measures the degree to which players are |
| proportion_sequence_breaking_actions_level2 | happy to interrupt their current actions. Another |
| proportion_sequence_breaking_actions_level3 | potential source of individual differences. |
| proportion_sequence_breaking_actions_level4 | |
| proportion_sequence_breaking_actions_level5 | |
| proportion_sequence_breaking_actions_level6 | |
| proportion_sequence_breaking_actions_level7 | |
| proportion_sequence_breaking_actions_level8 | |
| proportion_sequence_breaking_actions_level9 | |
| proportion_sequence_breaking_actions_level10 | |
| proportion_sequence_breaking_actions_mean | |
| proportion_sequence_breaking_actions_regression_on_gameplay_time | |
| proportion_sequence- | |
| breaking_post- | |
| selection_actions_level1 | |
| proportion_sequence- | |
| breaking_post- | |
| selection_actions_level2 | |
| proportion_sequence- | |
| breaking_post- | |
| selection_actions_level3 | |
| proportion_sequence- | |
| breaking_post- | |
| selection_actions_level4 | |
| proportion_sequence- | |
| breaking_post- | |
| selection_actions_level5 | |
| proportion_sequence- | |
| breaking_post- | |
| selection_actions_level6 | |
| proportion_sequence- | |
| breaking_post- | |
| selection_actions_level7 | |
| proportion_sequence- | |
| breaking_post- | |
| selection_actions_level8 | |
| proportion_sequence- | |
| breaking_post- | |
| selection_actions_level9 | |
| proportion_sequence- | |
| breaking_post- | |
| selection_actions_level10 | |
| proportion_sequence- | |
| breaking_post- | |
| selection_actions_mean | |
| proportion_sequence- | |
| breaking_post- | |
| selection_actions_regression_on_gameplay_time | |
| post- | |
| selection_latency_to_next_action_level1 | |
| post- | |
| selection_latency_to_next_action_level2 | |
| post- | |
| selection_latency_to_next_action_level3 | |
| post- | |
| selection_latency_to_next_action_level4 | |
| post- | |
| selection_latency_to_next_action_level5 | |
| post- | |
| selection_latency_to_next_action_level6 | |
| post- | |
| selection_latency_to_next_action_level7 | |
| post- | |
| selection_latency_to_next_action_level8 | |
| post- | |
| selection_latency_to_next_action_level9 | |
| post- | |
| selection_latency_to_next_action_level10 | |
| post- | |
| selection_latency_to_next_action_mean | |
| post- | |
| selection_latency_to_next_action_regression_on_gameplay_time | |
| longest_event_delay_ms_level1 | This game feature measures the longest delay between |
| longest_event_delay_ms_level2 | mouse click events. A long delay is meant to indicate |
| longest_event_delay_ms_level3 | that a player is not actively participating in playing the |
| longest_event_delay_ms_level4 | game. As well as a potential source of individual |
| longest_event_delay_ms_level5 | differences, features like this can also help determine |
| longest_event_delay_ms_level6 | player's level of engagement in a game. Different |
| longest_event_delay_ms_level7 | versions of the game can then be tested to iteratively |
| longest_event_delay_ms_level8 | improve these metrics and thus also hopefully improve |
| longest_event_delay_ms_level9 | how engaging the game is. |
| longest_event_delay_ms_level10 | |
| longest_event_delay_ms_mean | |
| customer_approach_time_ms_level1 | In these features “customer” refers to the non-player |
| customer_approach_time_ms_level2 | characters in the game that need to be served with items |
| customer_approach_time_ms_level3 | for them to consume in the game. So this feature in |
| customer_approach_time_ms_level4 | particular, measures how long it takes for the player to |
| customer_approach_time_ms_level5 | approach new customers that are waiting to be served. |
| customer_approach_time_ms_level6 | |
| customer_approach_time_ms_level7 | |
| customer_approach_time_ms_level8 | |
| customer_approach_time_ms_level9 | |
| customer_approach_time_ms_level10 | |
| customer_approach_time_ms_mean | |
| customer_approach_time_ms_regression_on_gameplay_time | |
| customer_total_time_ms_level1 | |
| customer_total_time_ms_level2 | |
| customer_total_time_ms_level3 | |
| customer_total_time_ms_level4 | |
| customer_total_time_ms_level5 | |
| customer_total_time_ms_level6 | |
| customer_total_time_ms_level7 | |
| customer_total_time_ms_level8 | |
| customer_total_time_ms_level9 | |
| customer_total_time_ms_level10 | |
| customer_total_time_ms_mean | |
| customer_total_time_ms_regression_on_gameplay_time | |
| customers_cleared_per_nonbuggy_min_throughput_level1 | Features that refer to nonbuggy time periods (minutes |
| customers_cleared_per_nonbuggy_min_throughput_level2 | in this case) are excluding times when the game might |
| customers_cleared_per_nonbuggy_min_throughput_level3 | have been experiencing bugs from the analysis. Bugs |
| customers_cleared_per_nonbuggy_min_throughput_level4 | are determined to the best of the ability of the analysis |
| customers_cleared_per_nonbuggy_min_throughput_level5 | to spot them and bugs can go either under or over |
| customers_cleared_per_nonbuggy_min_throughput_level6 | reported. Many game play sessions will have no bugs, |
| customers_cleared_per_nonbuggy_min_throughput_level7 | in which case the feature is computed over the whole |
| customers_cleared_per_nonbuggy_min_throughput_level8 | time the game is played. This particular feature |
| customers_cleared_per_nonbuggy_min_throughput_level9 | measures the rate (per minute) that customers are |
| customers_cleared_per_nonbuggy_min_throughput_level10 | cleared. Where a customer is cleared if their order is |
| customers_cleared_per_nonbuggy_min_throughput_mean | taken, they are served with the right item and leave. |
| correct1stguess_customers_cleared_per_nonbuggy_min_throughput_level1 | |
| correct1stguess_customers_cleared_per_nonbuggy_min_throughput_level2 | |
| correct1stguess_customers_cleared_per_nonbuggy_min_throughput_level3 | |
| correct1stguess_customers_cleared_per_nonbuggy_min_throughput_level4 | |
| correct1stguess_customers_cleared_per_nonbuggy_min_throughput_level5 | |
| correct1stguess_customers_cleared_per_nonbuggy_min_throughput_level6 | |
| correct1stguess_customers_cleared_per_nonbuggy_min_throughput_level7 | |
| correct1stguess_customers_cleared_per_nonbuggy_min_throughput_level8 | |
| correct1stguess_customers_cleared_per_nonbuggy_min_throughput_level9 | |
| correct1stguess_customers_cleared_per_nonbuggy_min_throughput_level10 | |
| correct1stguess_customers_cleared_per_nonbuggy_min_throughput_mean | |
| customers_leaving_unserved_proportion_level1 | |
| customers_leaving_unserved_proportion_level2 | |
| customers_leaving_unserved_proportion_level3 | |
| customers_leaving_unserved_proportion_level4 | |
| customers_leaving_unserved_proportion_level5 | |
| customers_leaving_unserved_proportion_level6 | |
| customers_leaving_unserved_proportion_level7 | |
| customers_leaving_unserved_proportion_level8 | |
| customers_leaving_unserved_proportion_level9 | |
| customers_leaving_unserved_proportion_level10 | |
| customers_leaving_unserved_proportion_mean | |
| eventful_clicks_per_nonbuggy_min_level1 | Eventful clicks are mouse clicks that resulted in some |
| eventful_clicks_per_nonbuggy_min_level2 | event. For example, clicking on an item caused the |
| eventful_clicks_per_nonbuggy_min_level3 | player character to pick it up. |
| eventful_clicks_per_nonbuggy_min_level4 | |
| eventful_clicks_per_nonbuggy_min_level5 | |
| eventful_clicks_per_nonbuggy_min_level6 | |
| eventful_clicks_per_nonbuggy_min_level7 | |
| eventful_clicks_per_nonbuggy_min_level8 | |
| eventful_clicks_per_nonbuggy_min_level9 | |
| eventful_clicks_per_nonbuggy_min_level10 | |
| eventful_clicks_per_nonbuggy_min_mean | |
| eventless_clicks_per_nonbuggy_min_level1 | Eventless clicks are clicks that resulted in no in-game |
| eventless_clicks_per_nonbuggy_min_level2 | action. Causes of this include that the player clicked on |
| eventless_clicks_per_nonbuggy_min_level3 | the wrong area, or they clicked on an area that was not |
| eventless_clicks_per_nonbuggy_min_level4 | currently active. It can measure both individual |
| eventless_clicks_per_nonbuggy_min_level5 | differences and potential bugs or poor game design. |
| eventless_clicks_per_nonbuggy_min_level6 | That is a person who repeatedly clicks on the something |
| eventless_clicks_per_nonbuggy_min_level7 | to no effect may not be very smart. It may also mean |
| eventless_clicks_per_nonbuggy_min_level8 | there is a bug. Or it may mean that the game is poorly |
| eventless_clicks_per_nonbuggy_min_level9 | designed. Other analysis, game modifications, and |
| eventless_clicks_per_nonbuggy_min_level10 | testing can sometimes determine which. |
| eventless_clicks_per_nonbuggy_min_mean | |
| total_clicks_per_nonbuggy_min_level1 | |
| total_clicks_per_nonbuggy_min_level2 | |
| total_clicks_per_nonbuggy_min_level3 | |
| total_clicks_per_nonbuggy_min_level4 | |
| total_clicks_per_nonbuggy_min_level5 | |
| total_clicks_per_nonbuggy_min_level6 | |
| total_clicks_per_nonbuggy_min_level7 | |
| total_clicks_per_nonbuggy_min_level8 | |
| total_clicks_per_nonbuggy_min_level9 | |
| total_clicks_per_nonbuggy_min_level10 | |
| total_clicks_per_nonbuggy_min_mean | |
| any_bug_longer_than_five_secs | This feature is a Boolean flag that indicates if the entire |
| | game play session contained any bugs that lasted more |
| | than 5 seconds. The inventors have sometimes found it |
| | useful to ignore such sessions entirely. The threshold |
| | of 5 seconds is somewhat arbitrary and can be varied |
| | based on empirical data, observation, or intuition. |
| nonbuggy_gameplay_until_1st_multidrink_carry_secs | How long did it take a player to figure out (if at all) that |
| | they could carry more than one drink at a time. |
| postinsight_mean_simultaneous_drinks_carried_to_sink | Once a player figured out that they could carry multiple |
| | drinks, how often did they do so. |
| ER_acc_under_90intensity | The emotional expressions the player has to recognize |
| | have varying intensities. The lower the intensity, the |
| | harder to recognize. So this feature measures the |
| | accuracy on emotions below 90% intensity. So |
| | specifically it excludes the 100% ones that might be |
| | much easier. |
| ER_acc_under_90intensity_regression_on_gameplay_time | Variable above regressed on game time. |
| ER_acc_under_70intensity | As above but with a 70% intensity threshold. |
| ER_acc_under_70intensity_regression_on_gameplay_time | Regressed on game time. |
| ER_acc_regression_on_intensity | How emotion recognition varies as a linear function of |
| | the emotion intensity. |

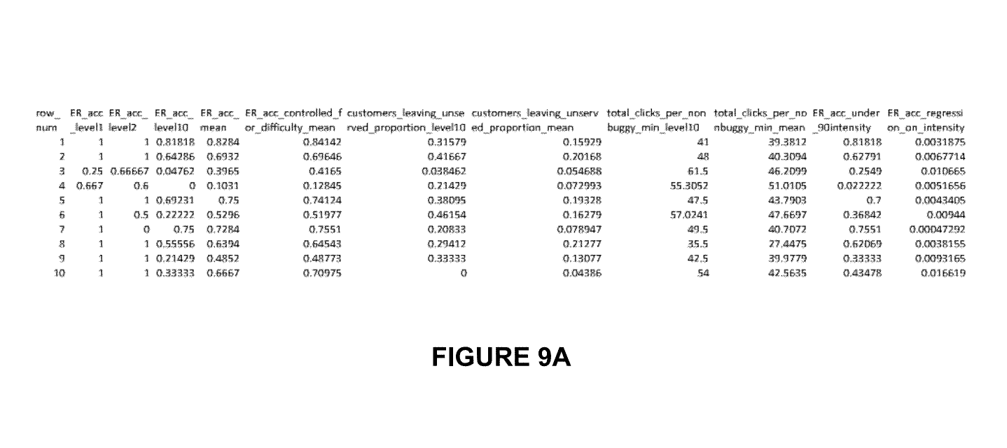

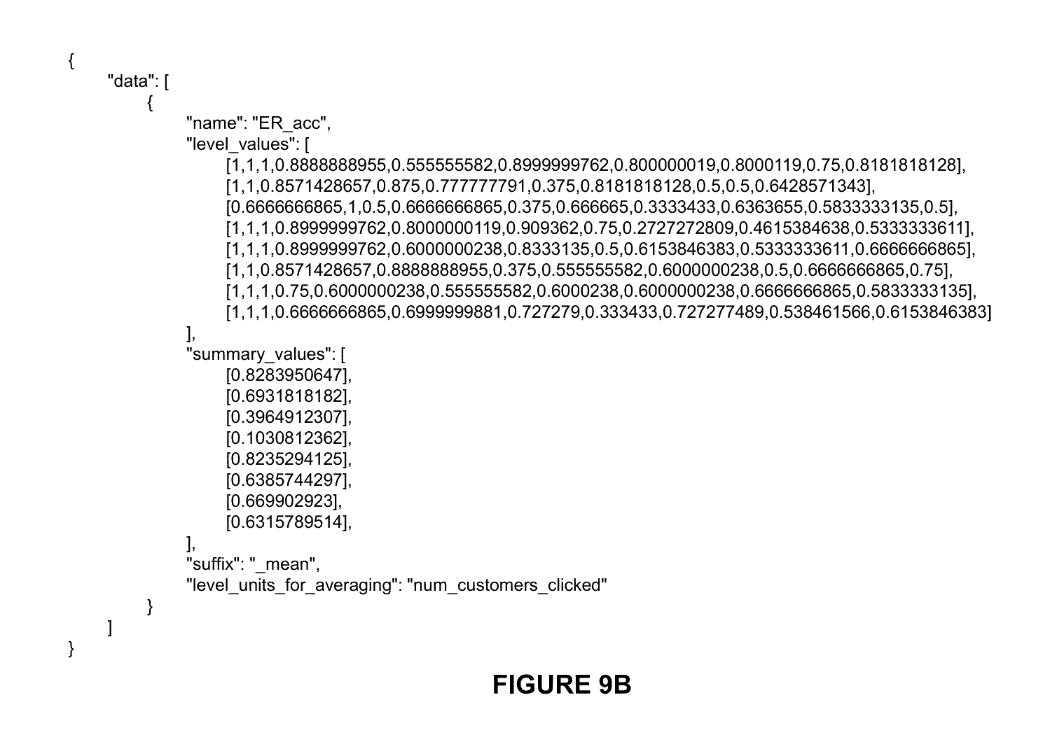

There are hundreds of example features listed in the table above. For a series of game play sessions, each feature is a column in a table and each row of the table corresponds to the values of those variables for a given session. In the special case where a different person plays each game session, each row of the table corresponds to a different person playing the game and the game features are representation of that person's behavior in the game. FIG. 9A illustrates a portion of that table with some representative values for some game features. FIG. 9B illustrates a structured data format for game feature values in which the part of the full table of data can be represented using JSON:

Game Feature Analysis

The game feature analysis described in this section is only a small example of what is possible using the system and method, but the system and method are not limited to only the particular game feature analysis described below.

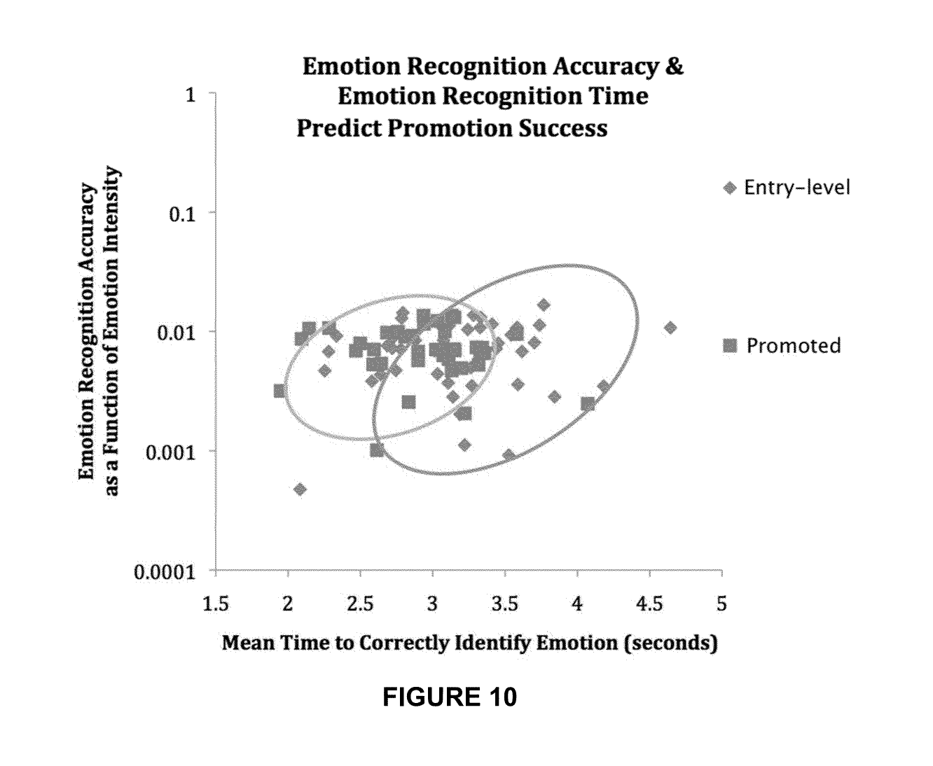

For example, in one study, a predictive profile for success was discovered known as a Promotion Success Factor. The Promotion Success Factor was calculated based on an individual's grade level and how they achieved that level. FIG. 10 is a chart showing the mapping of the prediction of promotion success based on emotion recognition accuracy (based on the game) and mean time to correctly identify the emotion. This factor indicates those individuals who have been promoted (the squares on the chart), versus those who are entry-level (diamonds on the chart) and have not yet been considered for promotion. Furthermore, in the chart, the blue “entry level” group are new hires and the red “promoted” group includes individuals who have been promoted. When the system performed logistic regression analysis to predict what factors accounted for membership in these groups, the analysis allows the system to predict binary outcomes and to control for many factors, including gender, age, and previous game-playing experience. The analysis predicts membership with 80% accuracy and the primary predictors of success in this sample are: (1) Accuracy at recognizing emotions when the emotion is subtly expressed; and (2) Response time to correctly identify emotions. Furthermore, the more successful individuals in this sample are more accurate and faster to correctly recognize emotions. The blue squares within the red circle indicate entry-level individuals who have potential for high performance, as indicated by the predictive pattern for promotion success. The few red squares outside the red circle indicate the possibility of additional patterns for success; these patterns can be discovered with more data.

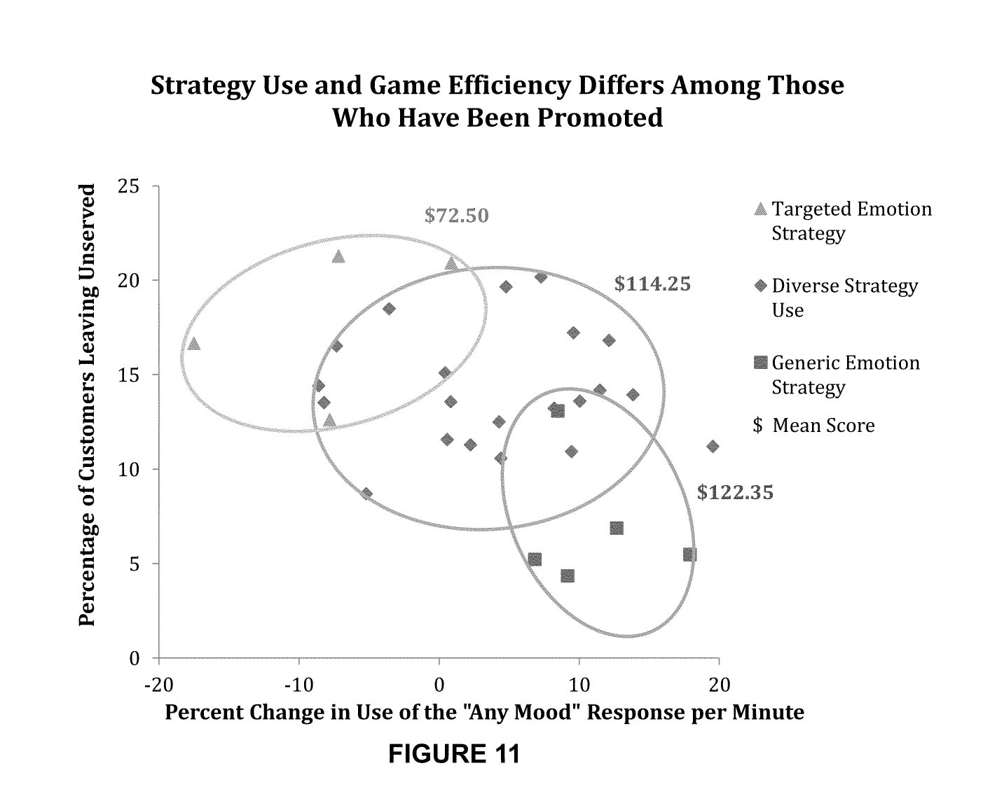

FIG. 11 is a chart that illustrates the strategy use and game efficiency differences between different person who have been promoted. A cluster analysis of emotion recognition, strategy, processing speed, and learning variables conducted on participants who have already been promoted revealed three distinct groups, most strongly distinguished by strategy use. The most efficient strategy implementation was use of the generic selection option, wherein as the game progressed and emotion recognition became increasingly difficult, participants learned to avoid costly mistakes by employing the “Any Mood” station thereby maintaining almost all of their customer throughput. This group scored highest in the game (as indicated above by the mean score in dollars), suggesting the most efficient strategy selection.

In contrast, a targeted approach also emerged, wherein participants used the “Any Mood” station infrequently in the latter stages of the game, and as a result lost more customers due to lengthy emotion recognition times. This group scored lowest in the game (again indicated by the mean score in dollars), and may have been more motivated by individual customer attention than by the overall score incentive.

The blue group in FIG. 11 adopts a more diverse approach, with both less extreme use of the “Any Mood” station and moderate flexibility with letting customers leaving. This suggests that when the game becomes more difficult these individuals do not change their use of “Any Mood” as much, instead allowing customers to leave if it allows them to maximize their score. Their score (in mean dollars) is close to that of those adopting the generic emotion strategy group.

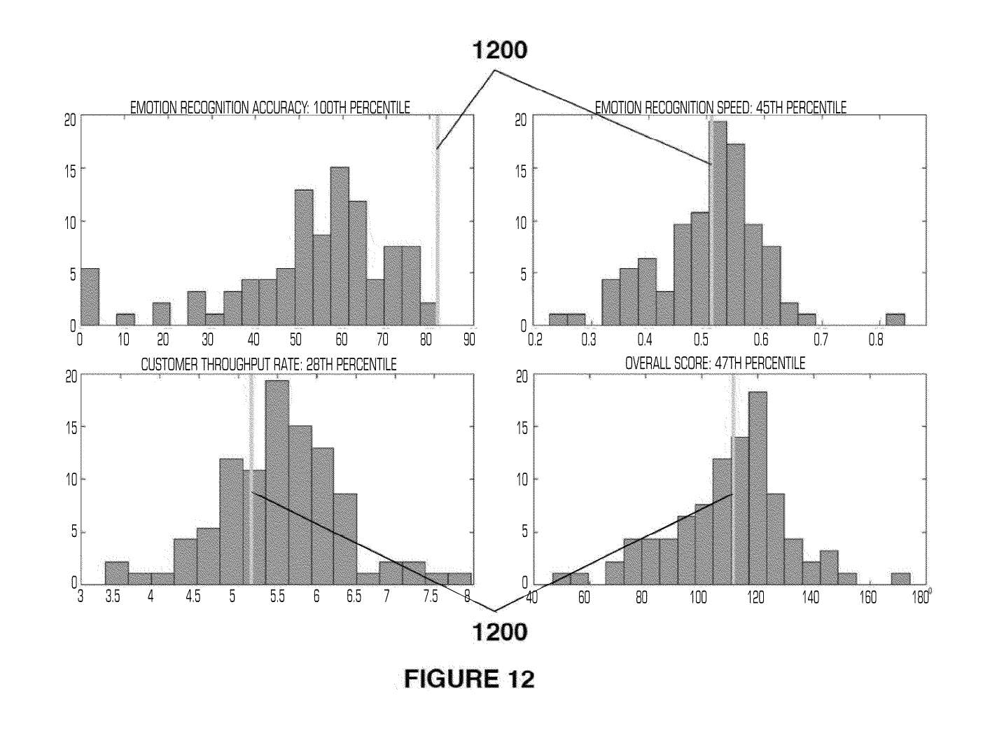

FIG. 12 illustrates a second type of game feature analysis using distribution charts. Many of the game features result in distributions that approximate a normal distribution and these can be used to see where a specific individual (shown by a green line 1200 in the distributions in FIG. 12) falls in these distributions. Those skilled in the art would recognize that it is straightforward to create further features out of the existing ones. For example, normalized features may be created by dividing the emotion recognition ability feature by the feature that measures throughput. This can be done in any standard programming language. For example, in Matlab the code to create this new feature is:

erCol = strmatch(“ER_acc_under_90intensity”,
all_game_variables.labels, “exact”);
tpCol =
strmatch(“customers_cleared_per_nonbuggy_min_throughput_mean”,
all_game_variables.labels, “exact”);
newGameFeature = all_game_variables.table(:, erCol) ./
all_game_variables.table(:, tpCol);

Those skilled in the art, would also recognize that further standards types of analysis are possible. For example, performing principal component analysis (PCA) is a common technique used to summarize the data in to a set of principal components that largely summarize the data. Typically, a large set of features can be summarized by a relatively smaller set of features that represent the principal components. This reduced set of features can be useful in itself, for example to discover clusters in the data; or as an input in to further analysis, for example as input into a machine learning algorithm.

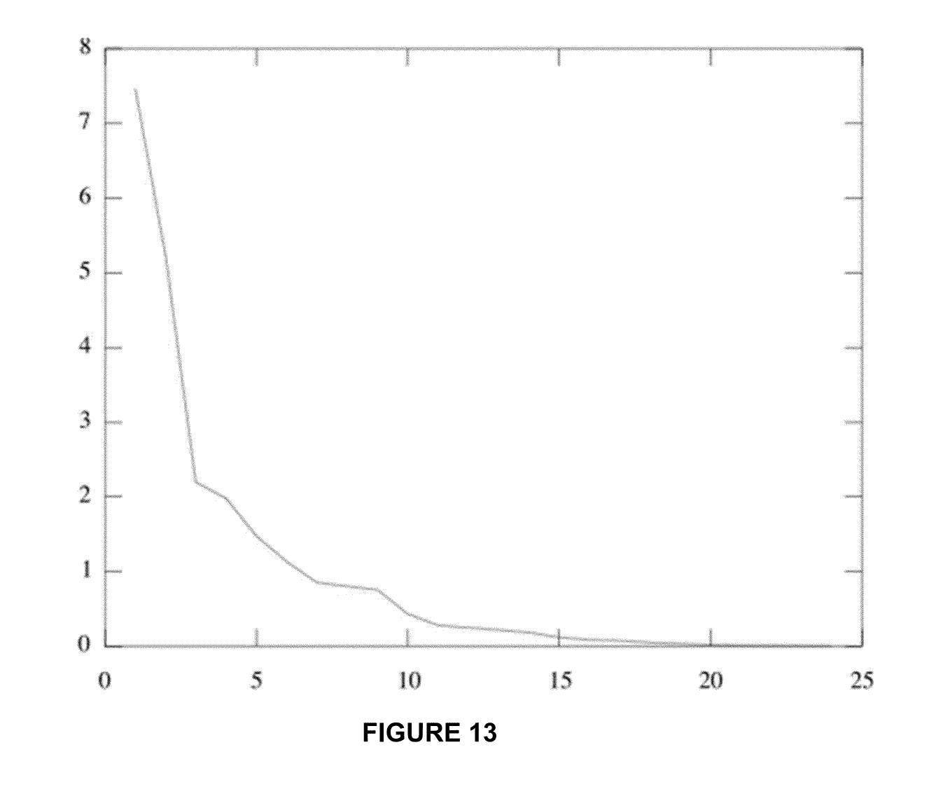

FIG. 13 illustrates a third type of game feature analysis using graph plots. This graph plots the eigenvalues of the different principal components. The magnitude of each eigenvalue indicates the amount of contribution of the corresponding eigenvector (each eigenvector is a computed linear combination of the original game features). As expected, the magnitude of the eigenvalues falls off sharply indicating that the first few eigenvectors do a relatively good job of representing the data.

Now, examples of some of the different environments for the system are described.

Employment Embodiment

In one embodiment, the results of analyzing data that includes data generated from people playing computer games are used to predict job performance, fit and compatibility, and preferences. For example, suppose the MSP is an employment matching service that uses the data analysis results to help match people to jobs, and jobs to people. A potential employer is one example of a potential MSC and a potential employee is another example. The employment opportunity can include any kind of exchange of money, goods or services for labor, including full-time employment, part-time employment, contractors, contracting services provided directly or through a third-party.

In one example, in the employment context, an employer may have one or more desirable profiles for workers (with certain attributes for a particular type of worker or certain different attributes for different types of workers that the employer is searching for) and those desirable profiles may be compared to the profile of the game player to assess/recommend a particular job opportunity/opportunities to the job seeker.

The system, in the special case when the matching service is a separate business entity to the potential employer, can keep the identity of the potential employees hidden and charge employers to connect with potential employees. The degree of the match can be used as an input to determine how much to charge. For example, a perfect match could cost a lot of money to connect with, but a less perfect match could be cheaper to connect with.

If the employer agrees to pay to connect to one or more potential candidates then payment could be contingent on whether the candidate accepts the invitation. In the special case that the GDP is some other company, it can be good business to give the GDP or GP a share of the money in the case that the individual agrees to connect to the potential employer.

It is sometimes good business practice to have the potential candidate be contacted through the game or if it is a separate business entity from the MSP, at least through the GDP or GP. This allows the GDP or GP to track conversion rates and ensure that they are being appropriately compensated. It is also helpful to make sure that the game player understands clearly that they are being offered a job in the real world, and not a job in the game world. However, the disclosure does also apply to matching players to jobs in the game world.

It is sometimes good business practice to have the potential candidate be contacted from some other third party. For example, social media sites such as Facebook or LinkedIn might be customers of the matching service and could own the relationship with the potential candidate.

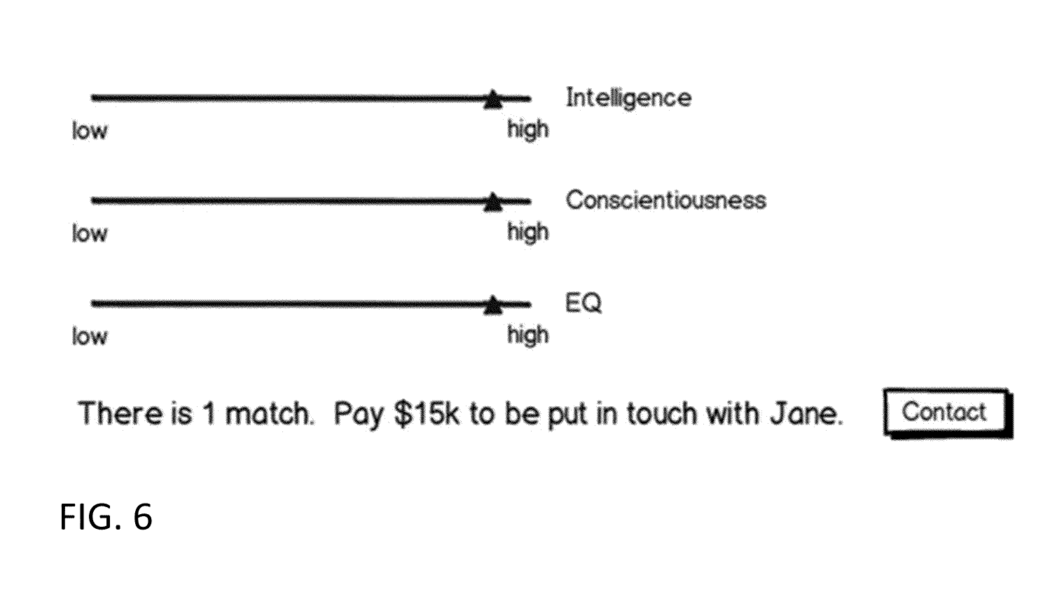

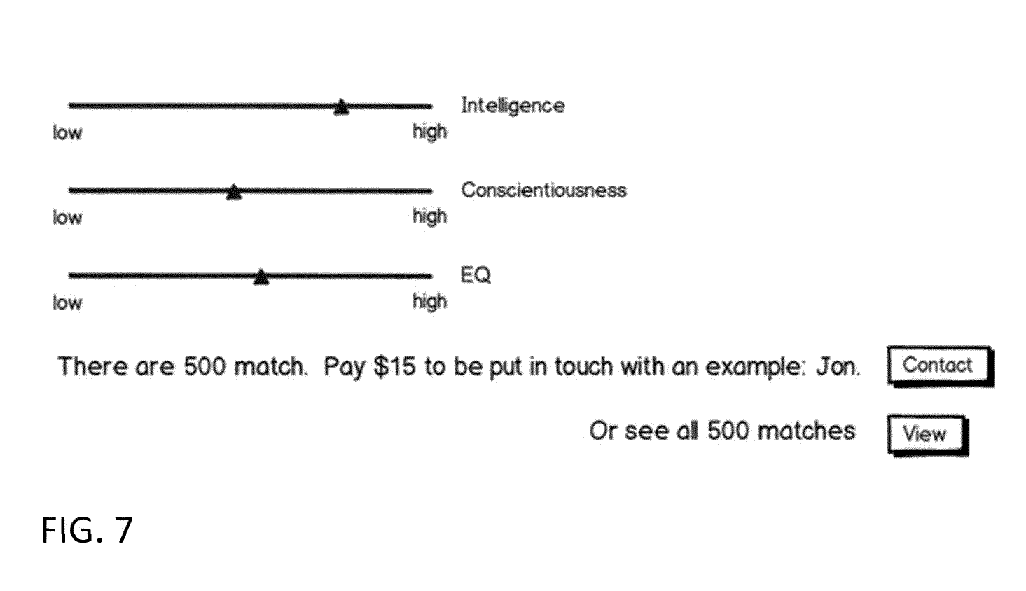

FIGS. 6 and 7 illustrate examples of a user interface for the system in FIG. 5 in an employment environment that allows a prospective employer to search for candidates that satisfy different criteria. In FIG. 6 the employer is looking for candidates who are highly intelligent, conscientious, and have high EQ. There might not be many candidates who meet this high bar, one in the example figure, and the prospective employer must therefore pay a high premium to contact the individual. In FIG. 7 the employer has relaxed their search criteria to ones that are perhaps more realistic and focus on the core attributes needed for the job. Consequently there are more potential matches and they are less expensive to contact. There is a button to contact a representative of the group as a sample or see all the matches. If a sample individual is requested then a person at the higher range would be shown so as to increase the chances of the employer asking for and paying for more matches.

FIGS. 6 and 7 are cast in terms of searching for individuals by named attributes, but the approach works equally well in the case that individuals are being measured for similarity in some vector space. Then the employer pays more for contact with matches that are closer to desirable employees.

FIGS. 6 and 7 show the disclosure in terms of searching for employees. But the same approach applies if searching for a date or a product. For example, in an advertising application it would potentially cost more to advertise to certain groups of people. Alternatively, the number of matches could simply be information used by the advertiser to determine the reach of their proposed campaign. For dating applications, it could potentially cost more to contact some people versus others, or the information could simply be information used by a person to determine how many people to search through.

School, College and University Embodiment

In another embodiment, the results of analyzing data that includes data generated from people playing computer games are used to predict school, college and university (undergraduate, graduate and postgraduate) performance, achievement, compatibility, and preferences.

For example, playing a game could be part of the college application and admission process. Or an applicant's profile previously derived from other game play data and information could be submitted as part of the application process, or even used to solicit applications.

As the student learns new skills and progresses in their education, additional data that includes data from games could be used to track the acquisition of skills, knowledge and progress over time.

Profiles could also be used to tailor courses or training programs to provide a highly personalized learning experience. Personalized training applications include those at schools, colleges, universities, other institutions, companies, as well as self-directed learning obtained by an individual. In addition, the educational institution (school, college, university, etc.) may have one or more desirable profiles for students (with certain attributes for a particular field of study or certain different attributes for different fields of study) and those desirable profiles may be compared to the profile of the game player to recommend a certain field of study or fields of study to the game player.

The system and method can also be used in training programs such as those designed to teach managers in an organization to become better managers. Firstly, the system and method allows the people being trained to have their abilities measured, secondly to see where they need to be trained, and thirdly to see how they improve or deteriorate over time.

Profiles can remain with students as they enter the work force and be used to apply for jobs and to solicit interest from companies searching for suitable candidates.

Dating Embodiment

In another embodiment, the results of analyzing data that includes data generated from people playing computer games are used to predict compatibility and preferences in human relationships in purely social contexts. For example, dating, finding friends, finding roommates, finding collaborators.

Many of the descriptions for the application of the system and method to the employment space have clear and obvious analogies to the dating space. For example, personality compatibility is widely considered to be an important factor in successful social relations. Moreover games are widely considered to be fun, lighthearted and whimsical so they might fit naturally into the dating process. People could either play games to determine a profile or advertise an existing profile. The profile may or may not be the same one used for other purposes, such as employment. The games might also be tailored to determine traits most relevant for social relationships or could be generic ones.

Badges and other information derived from the profiles can also be highly relevant to dating applications. For example, a credible “good listener” or “high EQ” badge could make a person's profile on a dating site a lot more popular.

Advertising Embodiment

In another embodiment, the results of analyzing data that includes data generated from people playing computer games are used to predict product and services compatibility, and preferences.

For services such as finding an accountant or doctor, the analogies from the employment application are direct. But traits, skills and personality also have significance for what products people will prefer. Therefore profiles are potentially useful for all kinds of consumer purchasing decisions. This includes recommending and advertising music, TV shows, movies, games and all kinds of media. Profiles are also useful for recommending other products such as automobiles, or any products sold in retail units, or on the web by retailers like Amazon. Companies like Amazon and Netflix already have powerful systems to recommend and advertise products to users; the profiles derived from data including game play data are another potentially valuable input into deriving such recommendations.

Companies like Google use web search data to target adverts to users and profiles could be another valuable input into those advert targeting algorithms. Profiles could also help deliver better search results.

The application to recommending and advertising products and services includes investment and other financial products, investment management and brokerage services, insurance and risk-management products, mortgage, bank accounts, credit and other debt products, and the like.

### OTHER EMBODIMENTS

Some medical conditions can be detected with performance-based testing. The invention therefore is also relevant in diagnosis, prediction, and personalized treatment recommendation for medical, mental, psychological and other health-related conditions. This could be done by deriving profiles with components with explicit meaning such as social sensitivity or intelligence. Scores on these components that were beyond a certain number of standard deviations from the mean could indicate the potential presence of medical conditions such as autism, dementia. The change in profiles over time could also show the progress of a disease or condition and could also show the effectiveness of medication and therapies.

Just as in the employment application, an alternative way to derive profiles that are representative of a class is to have representatives of the class generate data. For example, people who are known to have a condition such as autism or dementia could play a game to generate data. And then this data could be used to create one or more profiles that are representative of the disease or condition. Diagnosis of future potential suffers would then involve deriving their profile from suitable data and comparing that profile to the representative ones. The degree of similarity as measured by the matching distance could determine the diagnosis, or whether further medical tests were required, or even the dose or type of medication.

People may also want to use the invention to measure their abilities as part of a journey of self-discovery. For example, someone interested in the “quantified self” movement may want to use the invention to determine the effect that caffeine has on their cognitive performance. Or perhaps they may want to measure the effect of meditation or exercise as part of a program of self-improvement.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A method, comprising:
receiving game play data resulting from a player playing a game; and
deriving, based at least in part upon the game play data, a profile for the player, wherein the profile for the player includes an assessment for at least one of the following: one or more personality traits of the player, one or more personal preferences of the player, and one or more aptitudes of the player; and
wherein the method is performed by one or more computing devices.

2. The method of claim 1, wherein the game is designed to gauge one or more specific attributes of the player.

3. The method of claim 2, wherein the game is a computerized game that is instrumented to provide information pertaining to the one or more specific attributes of the player as output.

4. The method of claim 3, wherein deriving the profile for the player comprises:
processing the game play data to derive measurement information for the one or more specific attributes of the player; and
correlating the one or more specific attributes to at least one of the following: one or more personality traits of the player, one or more personal preferences of the player, and one or more aptitudes of the player.

5. The method of claim 4, wherein deriving the profile for the player further comprises:
generating, based at least in part upon the measurement information for the one or more specific attributes of the player, an assessment for at least one of the following: one or more personality traits of the player, one or more personal preferences of the player, and one or more aptitudes of the player.

6. The method of claim 5, wherein the game play data includes measurement information for the one or more specific attributes of the player.

7. The method of claim 5, wherein the game play data includes playing information that indicates actions and decisions made by the player while playing the game and context information that gives meaning to the actions and decisions made by the player.

8. The method of claim 7, wherein processing the game play data comprises:
interpreting the playing information and the context information to derive measurement information for the one or more specific attributes of the player.

9. The method of claim 1, further comprising:
determining, based at least in part upon the profile for the player, suitability of the player for a particular occupation.

10. The method of claim 1, further comprising:
determining, based at least in part upon the profile for the player and a desirable profile associated with a particular occupation, suitability of the player for the particular occupation.

11. The method of claim 1, further comprising:
recommending, based at least in part upon the profile for the player, one or more occupations for which the user is likely suitable.

12. The method of claim 1, further comprising:
recommending, based at least in part upon the profile for the player and a desirable profile associated with a particular occupation, the particular occupation as an occupation for which the user is likely suitable.

13. The method of claim 1, further comprising:
determining, based at least in part upon the profile for the player, suitability of the player for a particular field of study.

14. The method of claim 1, further comprising:
determining, based at least in part upon the profile for the player and a desirable profile associated with a particular field of study, suitability of the player for the particular field of study.

15. The method of claim 1, further comprising:
recommending, based at least in part upon the profile for the player, one or more fields of study for which the user is likely suitable.

16. The method of claim 1, further comprising:
recommending, based at least in part upon the profile for the player and a desirable profile associated with a particular field of study, the particular field of study as a field of study for which the user is likely suitable.

17. The method of claim 1, further comprising:
determining, based at least in part upon the profile for the player, whether the player is likely to be socially compatible with a particular person.

18. The method of claim 1, further comprising:
recommending, based at least in part upon the profile for the player, one or more persons with whom the player is likely to be socially compatible.

19. The method of claim 1, further comprising:
determining, based at least in part upon the profile for the player, whether an investment product is likely to be suitable for the player.

20. The method of claim 1, further comprising:
recommending, based at least in part upon the profile for the player, one or more investment products likely to be suitable for the player.

21. The method of claim 1, further comprising:
recommending, based at least in part upon the profile for the player, one or more products or services to be advertised or presented to the player.

22. The method of claim 1, further comprising:
generating, based at least in part upon the profile for the player, a diagnosis for the player.

23. A method, comprising:
receiving a first set of game play data resulting from a player playing a first game;
receiving a second set of game play data resulting from the player playing a second game, wherein the second game is different from the first game; and
deriving, based at least in part upon the first and second sets of game play data, a profile for the player, wherein the profile for the player includes an assessment for at least one of the following: one or more personality traits of the player, one or more personal preferences of the player, and one or more aptitudes of the player;
wherein the method is performed by one or more computing devices.

24. The method of claim 23, wherein the first game is designed to gauge a first set of one or more specific attributes of the player and the second game is designed to gauge a second set of one or more specific attributes of the player, wherein the second set of one or more specific attributes is different from the first set of one or more specific attributes.

25. The method of claim 24, wherein deriving the profile for the player comprises:
processing the first and second sets of game play data to derive measurement information for the first set of one or more specific attributes and measurement information for the second set of one or more specific attributes; and
correlating the first set of one or more specific attributes and the second set of one or more specific attributes to at least one of the following: one or more personality traits of the player, one or more personal preferences of the player, and one or more aptitudes of the player.

26. The method of claim 25, wherein deriving the profile for the player further comprises:
generating, based at least in part upon the measurement information for the first set of one or more specific attributes and the measurement information for the second set of one or more specific attributes, an assessment for at least one of the following: one or more personality traits of the player, one or more personal preferences of the player, and one or more aptitudes of the player.

27. A method, comprising:
receiving game play data resulting from a group of players playing a game; and
deriving, based at least in part upon the game play data, a group profile for the group of players, wherein the group profile includes an assessment for at least one of the following: one or more personality traits of the group of players, one or more personal preferences of the group of players, and one or more aptitudes of the group of players;
wherein the method is performed by one or more computing devices.

28. The method of claim 27, wherein the game play data includes a first set of game play data corresponding to a first player and a second set of game play data corresponding to a second player, and wherein deriving the group profile comprises:
deriving, based at least in part upon the first set of game play data, a first profile for the first player;
deriving, based at least in part upon the second set of game play data, a second profile for the second player; and
deriving the group profile based at least in part upon the first profile and the second profile.

29. A method, comprising:
creating a game that gauges one or more specific attributes of a player playing the game and collects information pertaining to the one or more specific attributes of the player; and
instrumenting the game to provide the information pertaining to the one or more specific attributes of the player as output.

30. The method of claim 29, wherein the game is a computerized game, and wherein creating the game comprises:
writing computer code that, when executed by one or more processors, causes the one or more processors to implement functionality that interacts with the player to gauge the one or more attributes of the player.

31. The method of claim 29, wherein the information pertaining to the one or more specific attributes of the player that is collected by the game includes measurement information for the one more specific attributes of the player.

32. The method of claim 29, wherein the information pertaining to the one or more specific attributes of the player that is collected by the game includes playing information that indicates actions and decisions made by the player while playing the game and context information that gives meaning to the actions and decisions made by the player.

33. A computer-readable storage medium storing instructions that, when executed by one or more processors, cause the one or more processors to implement a game that: interacts with a player to gauge one or more specific attributes of the player; collects information pertaining to the one or more specific attributes of the player; and provides the information pertaining to the one or more specific attributes of the player as output.

34. The computer-readable storage medium of claim 33, wherein the information pertaining to the one or more specific attributes of the player includes measurement information for the one more specific attributes of the player.

35. The computer-readable storage medium of claim 33, wherein the information pertaining to the one or more specific attributes of the player includes playing information that indicates actions and decisions made by the player while playing the game and context information that gives meaning to the actions and decisions made by the player.

36. A computer readable medium that stores a game play analysis system, the game play analysis system further comprising:
instructions that receive game play data resulting from a player playing a game; and
instructions that derive, based at least in part upon the game play data, a profile for the player, wherein the profile for the player includes an assessment for at least one of the following: one or more personality traits of the player, one or more personal preferences of the player, and one or more aptitudes of the player.

37. The computer readable medium of claim 36, wherein the game further comprises instructions that gauge one or more specific attributes of the player.

38. The computer readable medium of claim 36, wherein the instruction that derive the profile for the player further comprises:
instructions that process the game play data to derive measurement information for the one or more specific attributes of the player; and
instructions that correlate the one or more specific attributes to at least one of the following: one or more personality traits of the player, one or more personal preferences of the player, and one or more aptitudes of the player.

39. The computer readable medium of claim 38, wherein the instructions that derive the profile for the player further comprises:
instructions that generate, based at least in part upon the measurement information for the one or more specific attributes of the player, an assessment for at least one of the following: one or more personality traits of the player, one or more personal preferences of the player, and one or more aptitudes of the player.

40. The computer readable medium of claim 39, wherein the game play data includes measurement information for the one or more specific attributes of the player.

41. The computer readable medium of claim 39, wherein the game play data includes playing information that indicates actions and decisions made by the player while playing the game and context information that gives meaning to the actions and decisions made by the player.

42. The computer readable medium of claim 41, wherein the instructions that process the game play data comprises instructions that interpret the playing information and the context information to derive measurement information for the one or more specific attributes of the player.

43. The computer readable medium of claim 36, further comprising instructions that determine, based at least in part upon the profile for the player, suitability of the player for a particular occupation.

44. The computer readable medium of claim 36, further comprising instructions that determine, based at least in part upon the profile for the player and a desirable profile associated with a particular occupation, suitability of the player for the particular occupation.

45. The computer readable medium of claim 36 further comprising instructions that recommend, based at least in part upon the profile for the player, one or more occupations for which the user is likely suitable.

46. The computer readable medium of claim 36, further comprising instructions that recommend, based at least in part upon the profile for the player and a desirable profile associated with a particular occupation, the particular occupation as an occupation for which the user is likely suitable.

47. The computer readable medium of claim 36, further comprising instructions that determine, based at least in part upon the profile for the player, suitability of the player for a particular field of study.

48. The computer readable medium of claim 36, further comprising instructions that determine, based at least in part upon the profile for the player and a desirable profile associated with a particular field of study, suitability of the player for the particular field of study.

49. The computer readable medium of claim 36, further comprising instructions that recommend, based at least in part upon the profile for the player, one or more fields of study for which the user is likely suitable.

50. The computer readable medium of claim 36 further comprising instructions that recommend, based at least in part upon the profile for the player and a desirable profile associated with a particular field of study, the particular field of study as a field of study for which the user is likely suitable.

51. The computer readable medium of claim 36, further comprising instructions that determine, based at least in part upon the profile for the player, whether the player is likely to be socially compatible with a particular person.

52. The computer readable medium of claim 36, further comprising instructions that recommend, based at least in part upon the profile for the player, one or more persons with whom the player is likely to be socially compatible.

53. The computer readable medium of claim 36, further comprising instructions that determine, based at least in part upon the profile for the player, whether an investment product is likely to be suitable for the player.

54. The computer readable medium of claim 36, further comprising instructions that recommend, based at least in part upon the profile for the player, one or more investment products likely to be suitable for the player.

55. The computer readable medium of claim 36, further comprising instructions that recommend, based at least in part upon the profile for the player, one or more products or services to be advertised or presented to the player.

56. The computer readable medium of claim 36, further comprising instructions that generate, based at least in part upon the profile for the player, a diagnosis for the player.

57. A system for extracting value from game data, comprising:
one or more game data providers that each generate game play data about a game; and
a matching service provider that receives the game play data from the one or more game data providers and further comprises an analysis unit that analyzes the game play data and generates a characteristic of a user based on the game play data.

58. The system of claim 57 further comprising one or more matching service customers, wherein each matching service customer receives the characteristic.

59. The system of claim 57, wherein the characteristic is one or more of personality attributes of a person who played the game, abilities of a person who played the game, aptitudes of a person who played the game, characteristics of a person who played the game, competencies of a person who played the game, dispositions of a person who played the game, traits of a person who played the game and skills of a person who played the game.

60. The system of claim 57, wherein each matching service customer is in one of a dating industry, an employment industry, an educational industry, a medical industry and an advertising industry.

61. The system of claim 57, wherein the matching service provider combines other data about the person during the analysis of the game data.

62. The system of claim 57, wherein the matching service provider generates a profile for the person.

63. The system of claim 62, wherein the matching service provider generates a group profile for two or more persons.

64. The system of claim 62, wherein the matching service provider generates a matching distance between a profile of a first person and a profile of a second person.

65. The system of claim 58, wherein the matching service customer defines a desirable profile.

66. The system of claim 65, wherein the desirable profile is one of an explicit profile and an implicit profile.

67. The system of claim 58, wherein the matching service customer generates a desirability classifier based on an independent desirable group criteria.

68. The system of claim 67, wherein the matching service provider further comprises a desirability search engine so that the matching service customer can search for desirable signatures and recommend one of a person and a product.

69. The system of claim 64, wherein the analysis unit performs one of principal component analysis and independent component analysis of the signatures.

70. A method for extracting value from game data, the method comprising:
receiving game play data from a person playing a game;
analyzing, by machine learning, the game play data of the person; and
generating, based on the analyzed game play data of the person, a recommendation for the person.

71. The method of claim 70, wherein analyzing the game play data further comprises combining the game play data with other data about a person to generate the recommendation.

72. The method of claim 70 further comprising generate a data analysis result for the person based on the game play data, the data analysis result is one of a personality attribute of the person who played the game, abilities of a person who played the game, aptitudes of a person who played the game, characteristics of a person who played the game, competencies of a person who played the game, dispositions of a person who played the game, traits of a person who played the game and skills of a person who played the game.

73. The method of claim 70 further comprising generating a profile for the person.

74. The method of claim 73 further comprising generating a group profile for two or more persons.

75. The method of claim 73 further comprising generating a matching distance between a profile of a first person and a profile of a second person.

76. The method of claim 73 further comprising defining a desirable profile.

77. The method of claim 76, wherein the desirable profile is one of an explicit profile and an implicit profile.

78. The method of claim 73 further comprising generating a desirability classifier based on an independent desirable group criteria.

79. The method of claim 73, wherein analyzing further comprises performing one of principal component analysis and independent component analysis.

80. The method of claim 70 further comprising recommending one of a person and a product.

81. An apparatus for extracting value from game data, comprising:
a matching service provider computer system that receives game play data due to a person playing a game; and
the matching service provider computer system further comprising an analysis unit that analyzes the game play data to generate a profile of the person based on the game play data.

82. The apparatus of claim 81, wherein the matching service provider computer system further comprises an engine that processes and summarizes the game play data.

83. The apparatus of claim 81, wherein the profile has one of personality attributes of a person who played the game, abilities of a person who played the game, aptitudes of a person who played the game, characteristics of a person who played the game, competencies of a person who played the game, dispositions of a person who played the game, traits of a person who played the game and skills of a person who played the game.

84. The apparatus of claim 81, wherein the matching service provider computer system combines other data about the person during the analysis of the game play data.

85. The apparatus of claim 81, wherein the matching service provider generates a group profile for two or more persons.

86. The apparatus of claim 81, wherein the matching service provider generates a matching distance between a profile of a first person and a profile of a second person.

87. The apparatus of claim 81, wherein the matching service provider generates a desirability classifier based on an independent desirable group criteria.

88. The apparatus of claim 87 wherein the matching service provider computer system further comprises a desirability search engine so that a matching service customer can search for desirable profiles.

89. The apparatus of claim 81, wherein the analysis unit performs one of principal component analysis and independent component analysis.

90. The apparatus of claim 81, wherein the matching service provider computer system further comprises a recommendation engine that recommends one of a person and a product.
